(19) United States
(12) Patent Application Publication
(10) Pub. No.: US 2026/0365948 A1
(43) Pub. Date: Nov. 19, 2026

(54) RAPID FERMENTATION PROCESS FOR MAKING ALCOHOLIC BEVERAGES

(71) Applicant: CERIA, INC., Arvada, CO (US)

(72) Inventor: Keith VILLA, Arvada, CO (US)

(21) Appl. No.: 19/157,184

(22) PCT Filed: Feb. 16, 2024
(86) PCT No.: PCT/US2024/016289

§ 371 Date: Aug. 15, 2025

Related U.S. Application Data
(60) Provisional application No. 63/446,657, filed on Feb. 17, 2023.
(60) Provisional application No. 63/472,547, filed on Jun. 12, 2023.

(51) Int. Cl. C12C 11/11; C12C 7/04; C12C 7/16; C12C 7/20; C12C 7/26

(52) U.S. Cl. CPC C12C 11/11; C12C 7/042; C12C 7/16; C12C 7/20; C12C 7/26

(57) ABSTRACT

Presently disclosed is a rapid method of producing alcohol-containing beverages, including beer, kombucha, hard seltzers, wines, ciders, hard teas, sake and distilled products. The method includes cooling the mixture after boiling and allowing yeast or other microorganisms to ferment the mixture at a warm temperature, for a short period of time. Staged oxygenation occurs during the fermentation process. An alcohol-containing beverage is produced in 1-2 days or less, saving costs by allowing delivery of a product to the consumer quickly, also reducing storage time and costs associated with extended fermentation such as utilities, water, labor and chemicals. The beverage may be enhanced by the addition of hops or hop flavor-active materials, spices, herbs, specialty malts, psychoactive materials, physiologically active materials, natural or artificial flavors, caffeine, vitamins and supplements, mineral supplements, proteins, herbs, spices, terpenes, cannabinoids, synthetic cannabinoids, mushrooms, psilocybin containing mushrooms, peyote, ayahuasca, mescaline or combinations thereof.

### FIELD

The present disclosure is directed to a rapid method of producing a fermented, alcoholic beverage, including beer, kombucha, hard seltzer, wine, sake, hard cider, hard tea, and distilled products. The final product can be ready for packaging in as little as 1 to 2 days, rather than the one to six weeks or more required for conventional production of fermented beverages, resulting in significant savings in cost, labor and materials.

### BACKGROUND

Traditional alcohol-containing beverages are produced by a fermentation process whereby yeast converts glucose and/or other fermentable sugars into alcohol and carbon dioxide gas (CO₂), resulting in an alcoholic, carbonated or non-carbonated product. In the case of beer, these fermentable sugars are in the “wort” (a mixture of malt, water and other fermentable materials that have been mashed (cooked) and boiled). In the case of kombucha, hard seltzer, hard tea, sake and distilled spirit wash, these fermentable sugars are a component in the unfermented base. In the case of wine and hard cider, these fermentable sugars are from the respective fruits. The fermentation process begins when the wort or unfermented base is transferred to a fermenting vessel and yeast is added. For beer brewed by traditional methods, this occurs in an anaerobic environment, at 10-15 °C, and takes one to six weeks to produce a final product.

A method that reduces the time required to produce alcohol-containing beverages will benefit alcoholic beverage producers by allowing them to deliver a product to the consumer more quickly, reducing storage time and costs.

### BRIEF SUMMARY

Traditionally, some of the flavors of many malt-based beverages, including beer, kombucha, distilled spirit wash and hard seltzer, originate during alcoholic fermentation of the brewing ingredients by the introduction of yeast. Provided is a rapid method of producing a fermented alcoholic malt beverage, where increased amounts of yeast are added to a relatively warm wort, or other fermentable base, and allowed to ferment at a warmer temperature. Also provided are methods of rapidly producing a fermented, non-malt containing alcoholic beverage using a fermentable sugar base to produce hard seltzers and hard teas; a rapid method of producing alcoholic hard ciders or wine using fruit juice, fruit concentrate or fruit cider, a rapid method of producing a fermented, non-malt containing alcoholic beverage using a fermentable white rice base and a rapid method of producing kombucha using tea, sugar and SCOBY.

A method of staged oxygenation is also employed by introducing oxygen gas at any time (0-100% through) during the fermentation process. Staged oxygenation keeps the yeast healthy and moves the yeast towards aerobic growth. Staged oxygenation can occur at any time during fermentative growth, which typically terminates at about 0 to 2.5° Plato.

For beer-type beverages, higher amounts of hops may also be added, as compared to traditional brewing methods, to adjust for increased hop compound losses due to the higher amounts of yeast that are used, as hop compounds tend to adhere to the yeast cell walls (Table 1). Flavor components may be adjusted by the addition of more hops, or hop flavor-active materials, spices, herbs, specialty malts, psychoactive materials, physiologically active materials, natural flavors and/or artificial flavors. Caffeine, vitamins and supplements, mineral supplements, proteins, herbs, teas, terpenes, and cannabinoids may also be added at any time in the process.

Presently disclosed is a method whereby a mixture of malt, with or without other fermentable materials (e.g., brewing adjuncts), and water is mashed and boiled to create wort (FIG. 3, steps 1 and 2). Yeast nutrients may be added at step 2 such as zinc at a concentration range from 0.05-5.0 mg/L, and/or copper at a concentration range from 0.01-2.0 mg/L, and an ammonium compound such as diammonium phosphate (DAP) at a concentration range from 100 mg/L-5000 mg/L. Rather than cooling to 10-15 °C after boiling as in a traditional fermentation process, the mixture is cooled to, and kept at, a relatively warm temperature of 20-40 °C (FIG. 3, step 2) before adding yeast (FIG. 3, step 3). Yeast will ferment at a very fast rate at this temperature, and the high amount of yeast added results in a shorter fermentative growth period. The mixture is allowed to ferment in an anaerobic or aerobic environment for 24-48 hours (FIG. 3, step 3) resulting in the formation of both alcohol and CO₂. Starting anywhere from 0-100% through the fermentation stage, O₂ gas is repeatedly injected for several seconds every 0.001-50 hours (referred to as “staged oxygenation”). Staged oxygenation occurs at the time range selected from the group consisting of 0-100%, 0-50%, 50-100%, 0-20%, 10-30%, 20-40%, 30-50%, 40-60%, 50-70%, 60-75%, 70-80%, 75-85%, 80-90%, 75-100% and 90-100% of the way through the fermentation process. Oxygen gas is injected for a time period in the time range selected from the group consisting of 0.01 seconds to 30 minutes, 0.01-30 seconds, 0.01-15 seconds, 0.1-1 seconds, 0-30 seconds, 0-15 seconds, 15-30 seconds, 0-5 seconds, 5-10 seconds, 10-15 seconds, 15-20 seconds, 20-25 seconds, 25-30 seconds, 30 seconds to 30 minutes, 1-30 minutes, 1-15 minutes, 15-30 minutes, 1-5 minutes, 5-10 minutes, 10-15 minutes, 15-20 minutes, 20-25 minutes and 25-30 minutes. The injection of oxygen gas is repeated for a time period in the time range selected from the group consisting of 0.001-50, 12-25, 12-40, 0.5-12, 6-12, 12-25, 25-50, 3-6, 1-3, 0.001-0.1, 1-6, 1-3, 1.25, 1.5, 1.75, 2, 2.25, 2.5, 2.75, 3, 3.25, 3.5, 3.75, 4, 4.25, 4.5, 4.75, 5, 5.25, 5.5, 5.75, 6, 12, 25, 40 and 50 hours. If the fermentation tank is larger than 2 barrels (bbl), agitation of the tank may be provided. The product is then cooled further and may or may not be filtered (FIG. 3, step 4). Carbonation may optionally be added. Other ingredients may be added such as hops or hop flavor-active materials, spices, herbs, specialty malts, psychoactive materials, physiologically active materials, natural or artificial flavors, caffeine, vitamins and supplements, mineral supplements, proteins, herbs, teas, spices, terpenes, cannabinoids, etc. at any time during the process. Any “off flavors” are addressed by the addition of yeast supplements and staged oxygenation.

Step 2 of the method includes cooling to only 20-40 °C, rather than cooling to typical fermentation temperatures of 10-15 °C, thereby requiring less energy for cooling which can be a cost savings. Also described are steps required to balance the rate of fermentation with the amount of yeast needed in order to completely ferment the mixture in 24-50 hours. While the method results in shortening the fermentation process from several weeks to just a few days, “off flavors” may be produced which can be addressed at different steps in the process.

In one embodiment, the method creates an alcoholic product. It is also possible to control the level of alcohol in the final product depending on the total contact time between the fermentable material and the yeast, combined with the length of time the mixture is held at the fermenting temperature.

In one embodiment, the cooled mixture may be partially or fully saturated with oxygen, by the addition of oxygen gas.

In one embodiment, yeast nutrients selected from the group consisting of zinc at a concentration range of 0.05-5.0 mg/L and/or copper at a concentration range from 0.01-2.0 mg/L, ammonium compounds such as diammonium phosphate (DAP) at a concentration range from 100 mg/L-5000 mg/L, yeast extract, magnesium, calcium, thiamine, biotin, free amino nitrogen, yeast hulls, wheat germ and commercially available yeast foods may be added. In one embodiment, yeast nutrients selected from the group consisting of zinc at a concentration range from 0.05-5.0 mg/L, and/or copper at a concentration range from 0.01-2.0 mg/L, ammonium compounds such as diammonium phosphate (DAP) at a concentration range from 100 mg/L-5000 mg/L, yeast extract, magnesium, calcium, thiamine, biotin, free amino nitrogen, yeast hulls, wheat germ and commercially available yeast foods are added.

In one embodiment, staged oxygenation is initiated during the fermentation stage by introducing oxygen gas to the cooled mixture. Oxygen gas is injected repeatedly for the time period selected from the group consisting of 0.01 seconds to 30 minutes, 0.01-30 seconds, 0.01-15 seconds, 0.1-1 seconds, 0-30 seconds, 0-15 seconds, 15-30 seconds, 0-5 seconds, 5-10 seconds, 10-15 seconds, 15-20 seconds, 20-25 seconds, 25-30 seconds, 30 seconds to 30 minutes, 1-30 minutes, 1-15 minutes, 15-30 minutes, 1-5 minutes, 5-10 minutes, 10-15 minutes, 15-20 minutes, 20-25 minutes and 25-30 minutes. at a rate selected from the group consisting of 0.000001-0.1, 0.1-0.5, 0.5-1, 1-5, 0.000001, 0.00001, 0.0001, 0.001, 0.01, 0.1, 0.5, 1, 1.5, 2, 2.5, 3, 3.5, 4, 4.5 and 5 liters per minute, and repeated for the time period selected from the group consisting of every 0.001-50, 12-25, 12-40, 0.5-12, 6-12, 12-25, 25-50, 3-6, 1-3, 0.001-0.1, 1-6, 1-3, 1.25, 1.5, 1.75, 2, 2.25, 2.5, 2.75, 3, 3.25, 3.5, 3.75, 4, 4.25, 4.5, 4.75, 5, 5.25, 5.5, 5.75, 6, 12, 25, 40 and 50 hours.

In one embodiment, the mixture is agitated or stirred, either mechanically or by directing the flow of oxygen, or other gas, to create mixing action.

In one embodiment, ammonium compounds, such as diammonium phosphate, are added at a concentration range from 100 mg/L-5000 mg/L to prevent or minimize a large drop in pH of the mixture as a natural reaction of rapid fermentation.

In one embodiment, zinc is added at a concentration range of 0.05-5.0 mg/L.

in one embodiment, copper is added at a concentration range of 0.01-2.0 mg/L.

In one embodiment, yeast addition takes place on the “cold” side, i.e., at approximately 30 °C, in the fermentation tank. Yeast type can include traditional brewer's yeast (e.g., Saccharomyces cerevisiae and Saccharomyces uvarum) but can also include other types of yeast such as baker's yeast, wine yeast, champagne yeast, distiller's yeast, sake yeast, symbiotic culture of bacteria and yeast (SCOBY), genetically modified yeast and any other type of domesticated, wild or industrial yeast and combinations thereof.

Genetically modified or classically modified yeast or other microorganisms, which possess genes and traits from other organisms, are also taught in this process.

In one embodiment, the method creates an alcoholic beverage in as much as 93% less time than conventional brewing methods.

In one embodiment the method creates an alcoholic beverage in 2 days. In one embodiment group consisting of 1 day, 12 hours, and less.

In one embodiment, the method creates an alcoholic beverage using as much as 25% less space than conventional brewing methods.

In one embodiment, the method creates an alcoholic beverage with as much as 10% lower cost than conventional brewing methods.

In one embodiment, tetrahydrocannabinol (THC) is added to the alcoholic beverage at a concentration selected from the group consisting of 0.0001-1%, 0.0001-5%, 0.0001-10%, 1-5%, 5-10%, 10-15%, 15-20%, 0.0001%, 0.0005%, 0.001%, 0.0015%, 0.002%, 0.0025%, 0.003%, 0.0035%, 0.004%, 0.0045%, 0.005% up to 1%, 2%, 3%, 4%, 5%, 6%, 7%, 8%, 9%, 10%, 11%, 12%, 13%, 14%, 15% and 20% by weight. In one embodiment this is added at 0.005%.

In one embodiment, terpenes and/or cannabinoids such as THC, CBD, CBN, CBG, etc. are added together or individually to the alcoholic beverage.

The entire process is rapid and produces an alcoholic beverage in as little as one day, as opposed to 1 to 6 weeks for the production of a traditional, alcoholic malt beverage, or longer for non-malt alcoholic beverages. In one embodiment, the entire process produces a finished product in the time less than or equal to a time selected from the group consisting of 12-24 hours, 24-72 hours, 72 hours-4 days, 4-14 days, 2 weeks to 4 weeks, 12 hours, 24 hours, 48 hours, 72 hours, 2 days, 4 days, 5 days, 6 days, 7 days, 8 days, 9 days, 10 days, 11 days, 12 days, 13 days, 14 days, 2 weeks, 3 weeks and 4 weeks.

In one embodiment, the method can produce a fermented product selected from the group consisting of amasi, amazake, ayran, beer, bionade, boza, Calpis, chal, champagne, chhang, chicha, cider, darassun, fassbrause, ginger beer, ginger beer/ale, hard tea, hard seltzer, hardaliye, jun, kombucha, kumis, lact ofermented soda, lambanog, lassi, mageu, makgeolli, mauby, mead, milk kefir, nut milk kefir, podpiwek, probiotic lemonade, pulque, rejuvelac, rice wine, root beer, sahti, sake, salgam, sikhye, sima, sweet potato fly, tejuino, tepache, toddy, water kefir, wine and yogurt.

### BRIEF DESCRIPTION OF THE DRAWINGS

FIG. 1 shows a diagram of a rapid fermentation brewing method that takes one to two days.

FIG. 2 shows a diagram of a traditional brewing method that takes two to six weeks.

FIG. 3 shows a flow chart of a method for rapid fermentation of a malt-based alcohol-containing beverage in one to two days. To induce staged oxygenation, oxygen gas is introduced during step 3, approximately 75% through the fermentation process.

FIG. 4A shows a diagram of a standard brewing process timeline for making beer that takes two to six weeks.

FIG. 4B shows a diagram of a standard brewing process timeline for making alcohol-containing seltzer that takes 8-10 days.

FIG. 4C shows a diagram of a rapid brewing process timeline for making beer or alcohol-containing seltzer that is ready for finishing and packaging in less than 48 hours.

FIGS. 5A-5L show detailed examples of the rapid brewing process, including staged oxygenation, where the fermentable sugar content is assessed by measuring either the degrees Plato or specific gravity, of the beverage over time. FIG. 5A is a graph of a rapid fermentation process showing staged oxygenation for making standard gravity beer or a malt-based hard seltzer. FIG. 5B is a graph of a rapid fermentation process showing staged oxygenation for making high gravity beer or malt-based hard seltzer. FIG. 5C is a graph of a rapid fermentation process showing staged oxygenation for making ultra-high gravity beer or malt-based hard seltzer. FIG. 5D is a graph of a rapid fermentation process showing staged oxygenation for making standard gravity hard seltzer fermented from a sugar base. FIG. 5E is a graph of a rapid fermentation process showing staged oxygenation for making high gravity hard seltzer fermented from a sugar base. FIG. 5F is a graph of a rapid fermentation process showing staged oxygenation for making ultra-high gravity hard seltzer fermented from a sugar base. FIG. 5G is a graph of a rapid fermentation process showing staged oxygenation for making wine. FIG. 5H is a graph of a rapid fermentation process showing staged oxygenation for making kombucha. FIG. 5I is a graph of a rapid fermentation process showing staged oxygenation for making distilled spirit wash. FIG. 5J is a graph of a rapid fermentation process showing staged oxygenation for making sake. FIG. 5K is a graph of a rapid fermentation process showing staged oxygenation for making hard cider. FIG. 5L is a graph of a rapid fermentation process showing staged oxygenation for making hard tea.

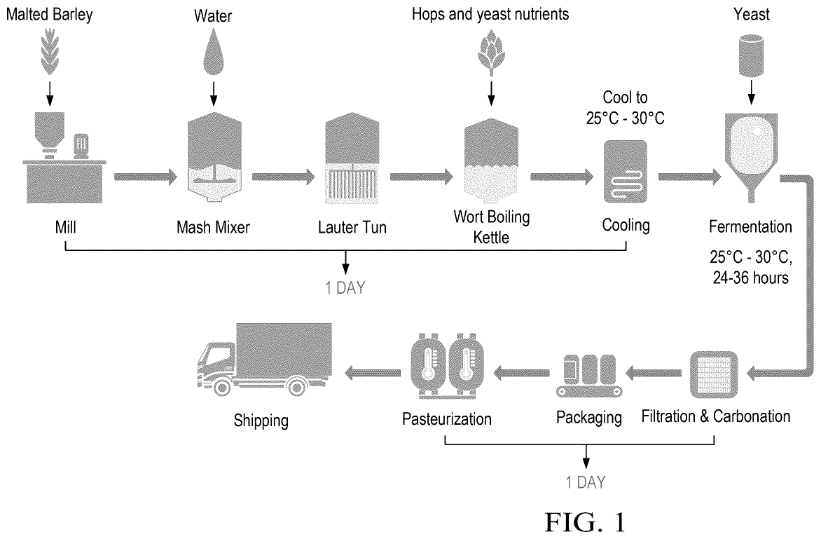

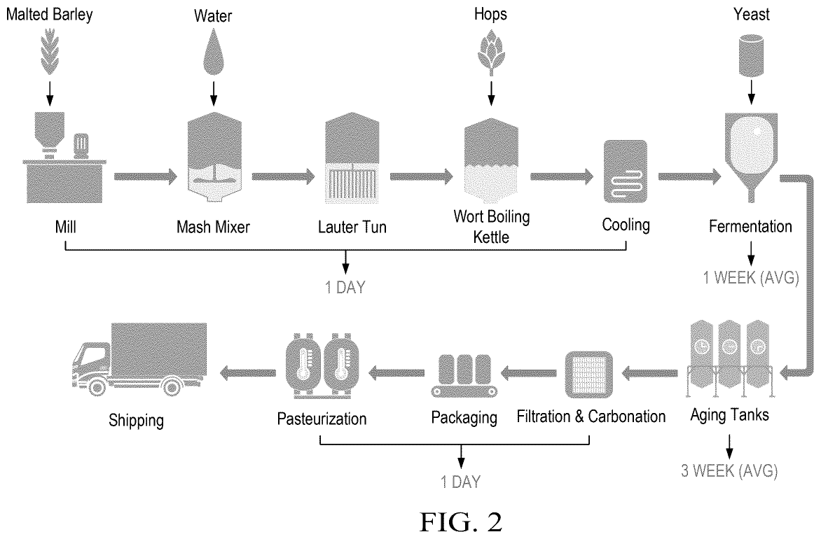

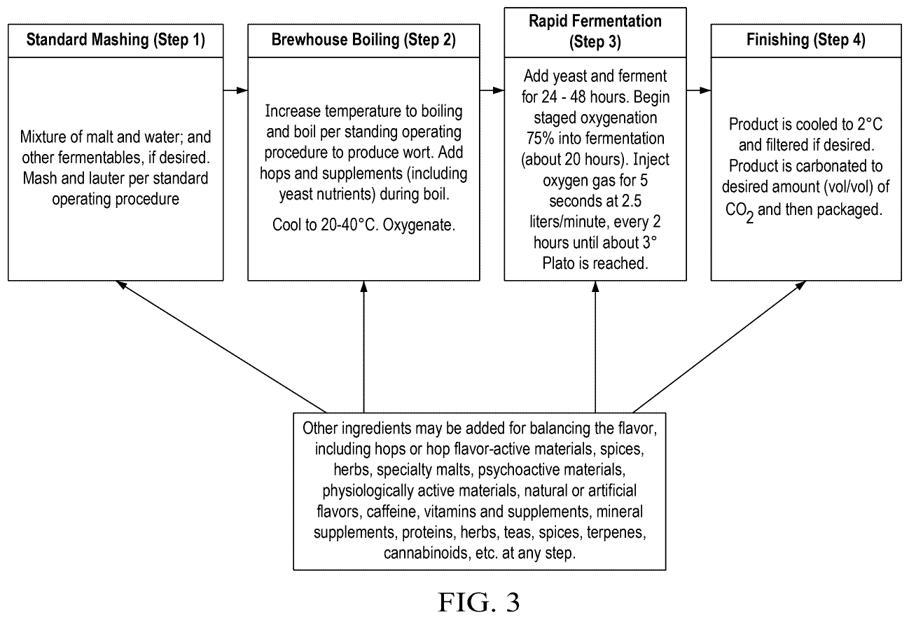

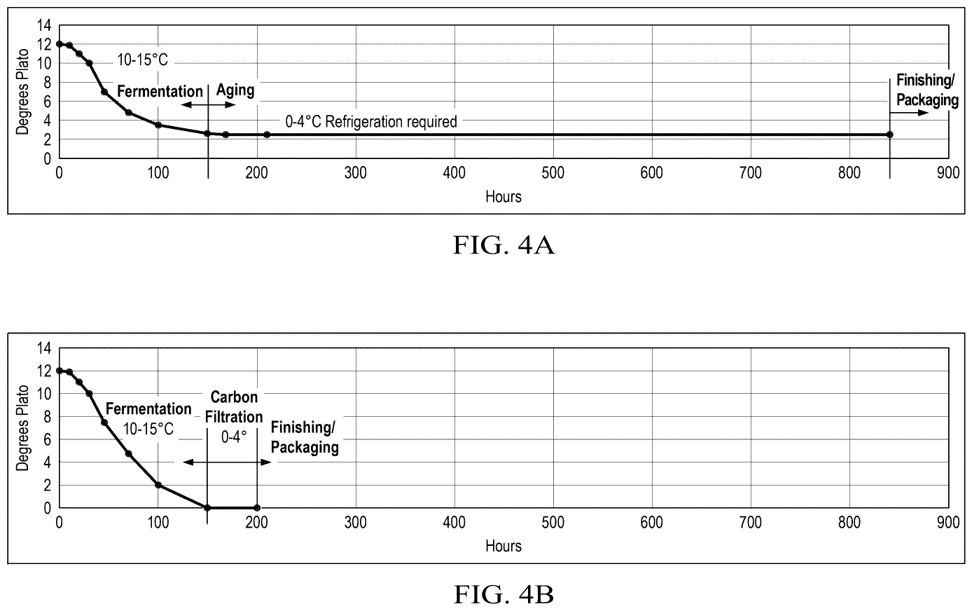

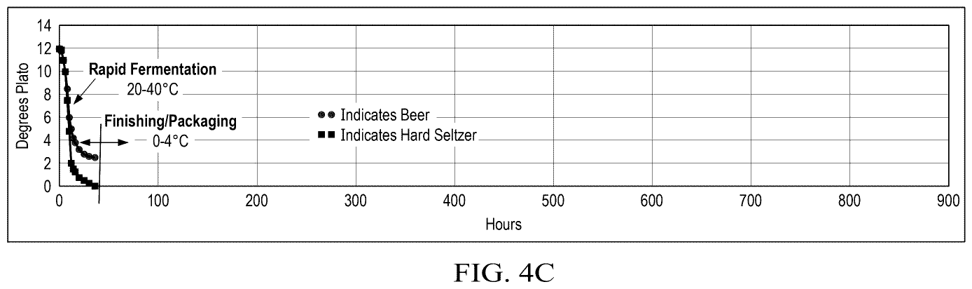

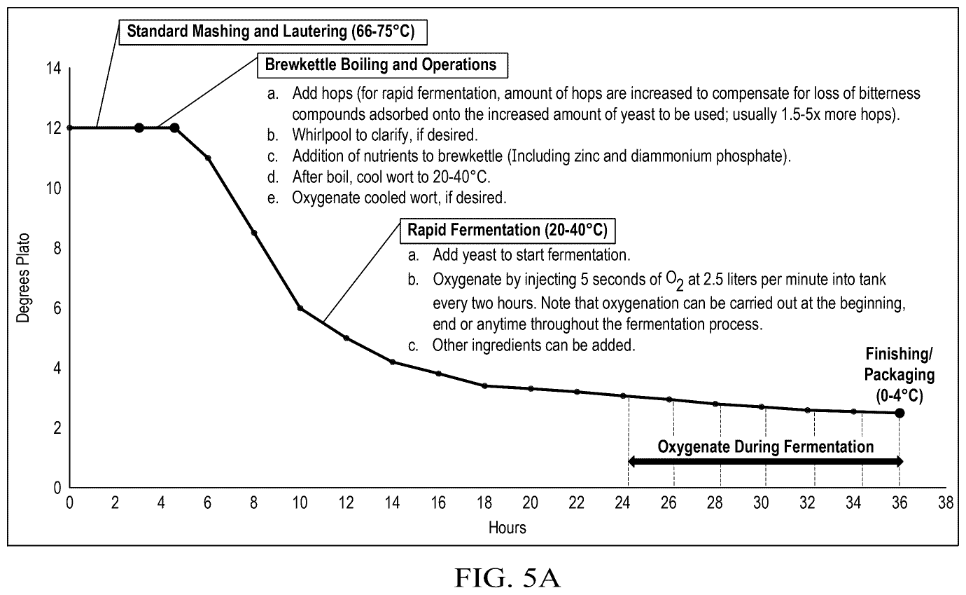

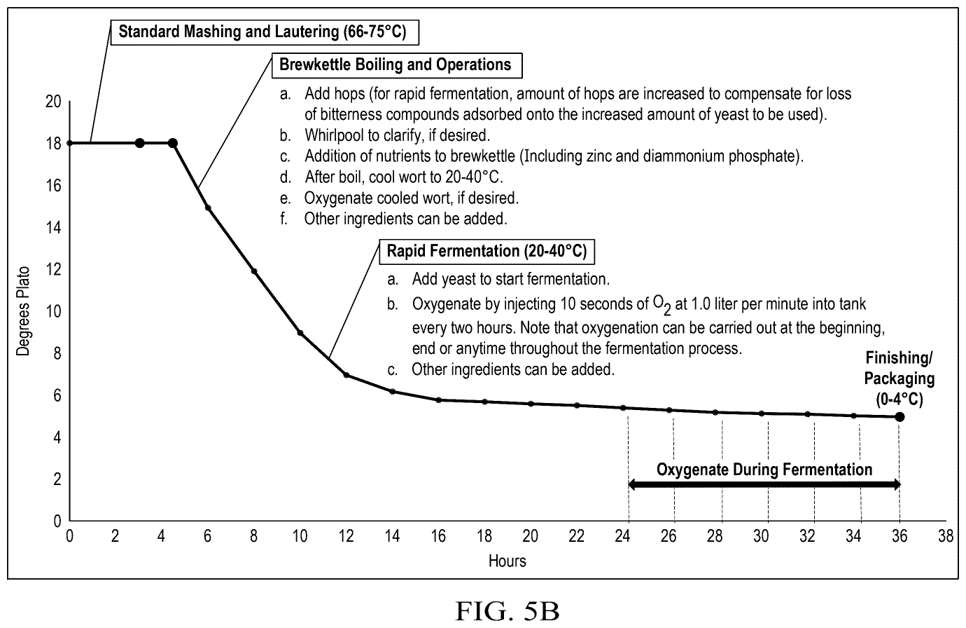

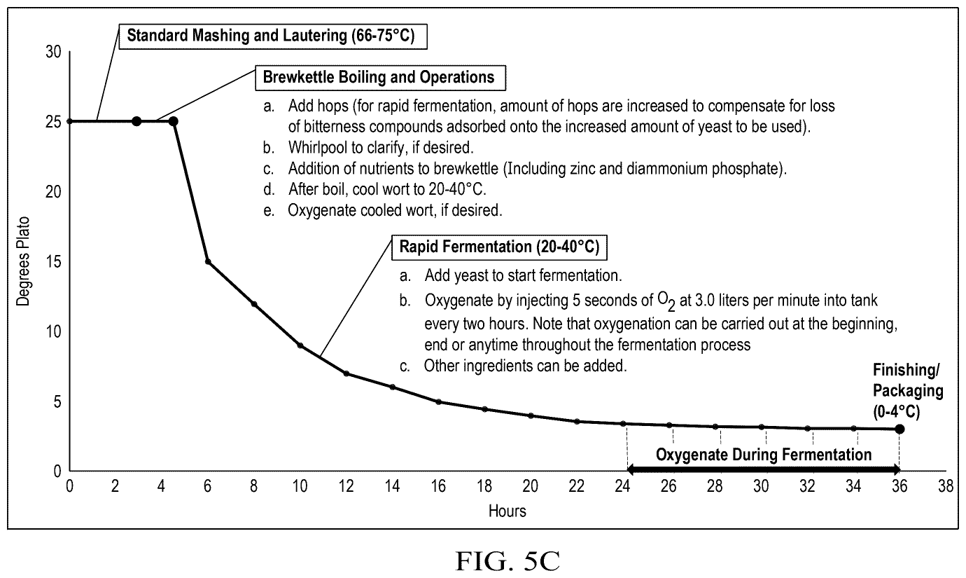

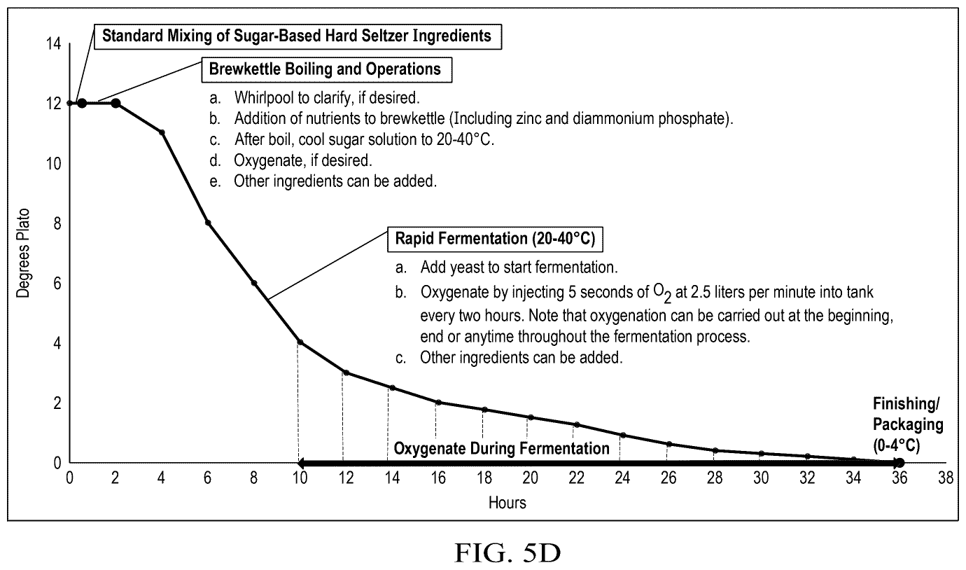

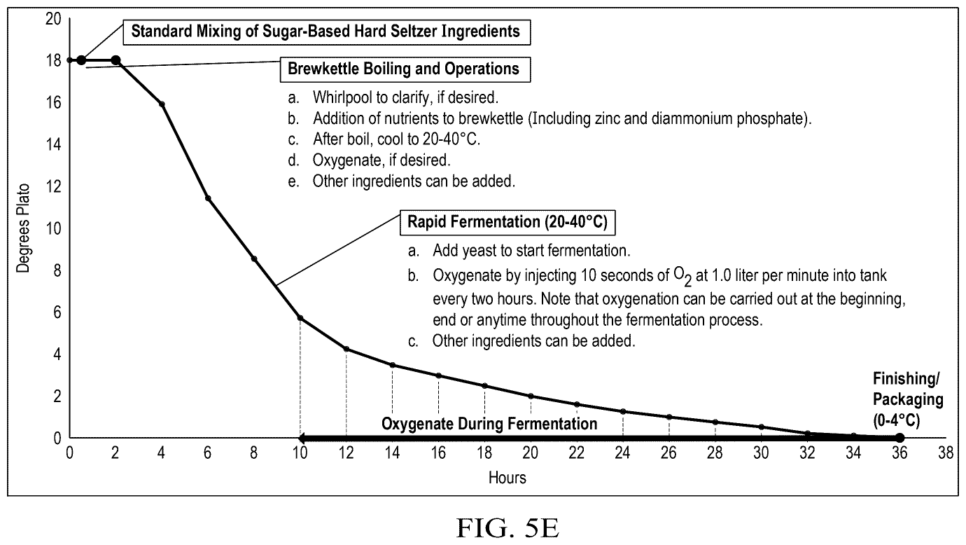

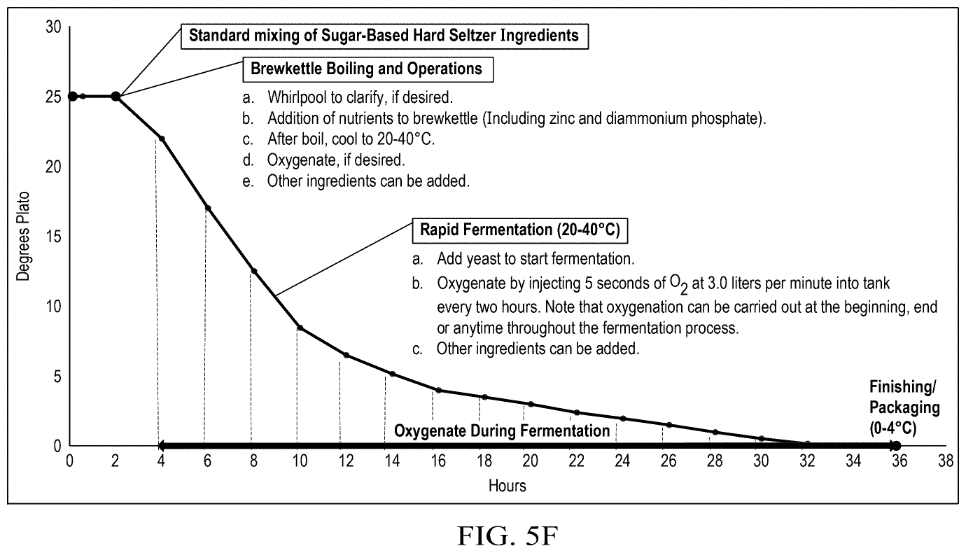

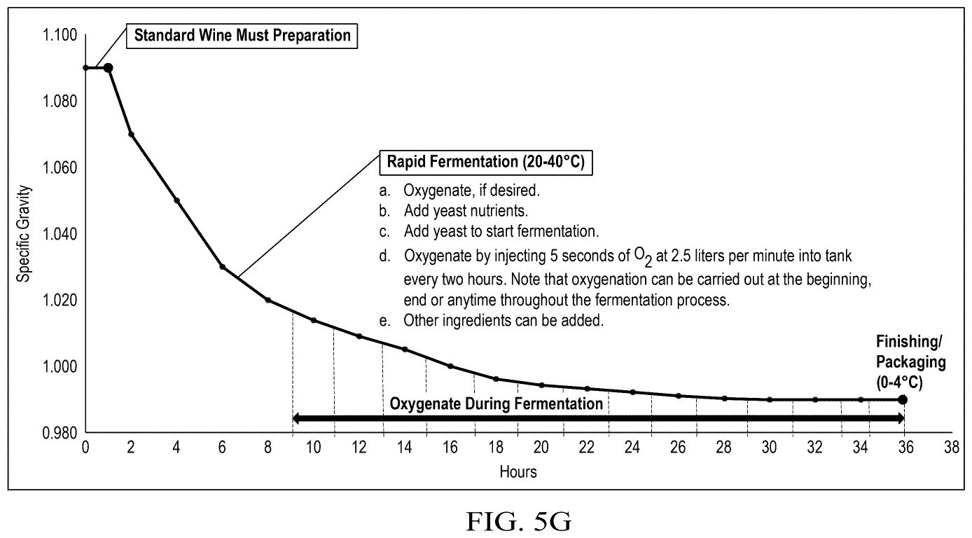

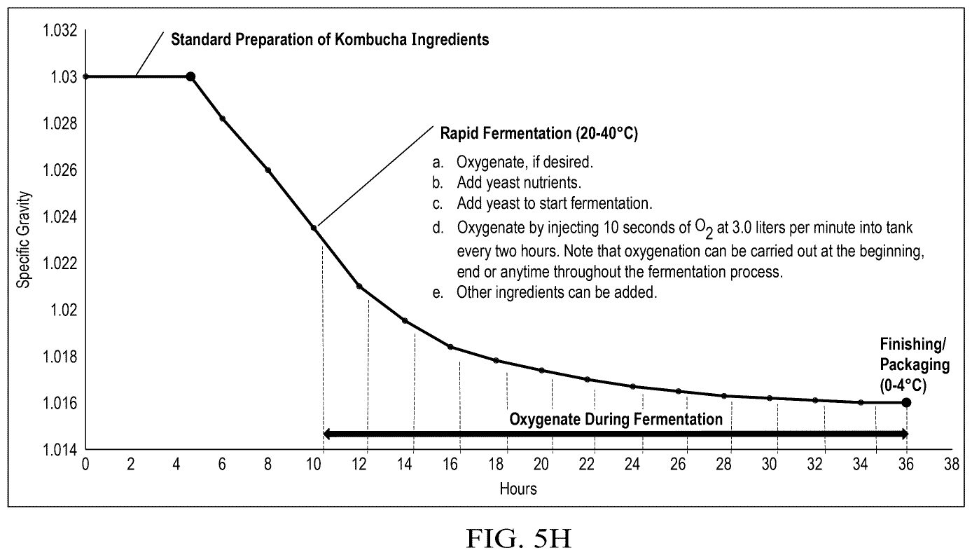

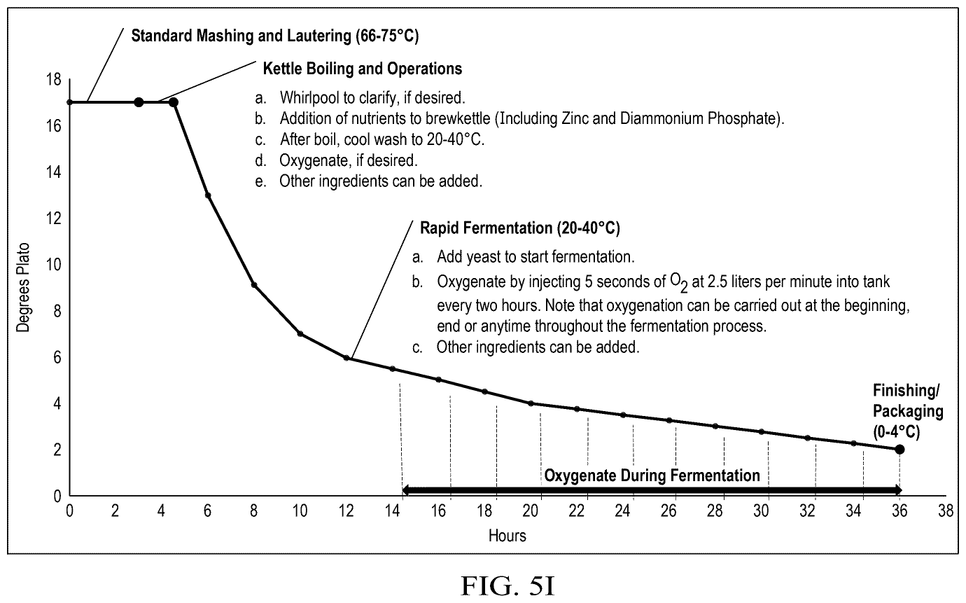

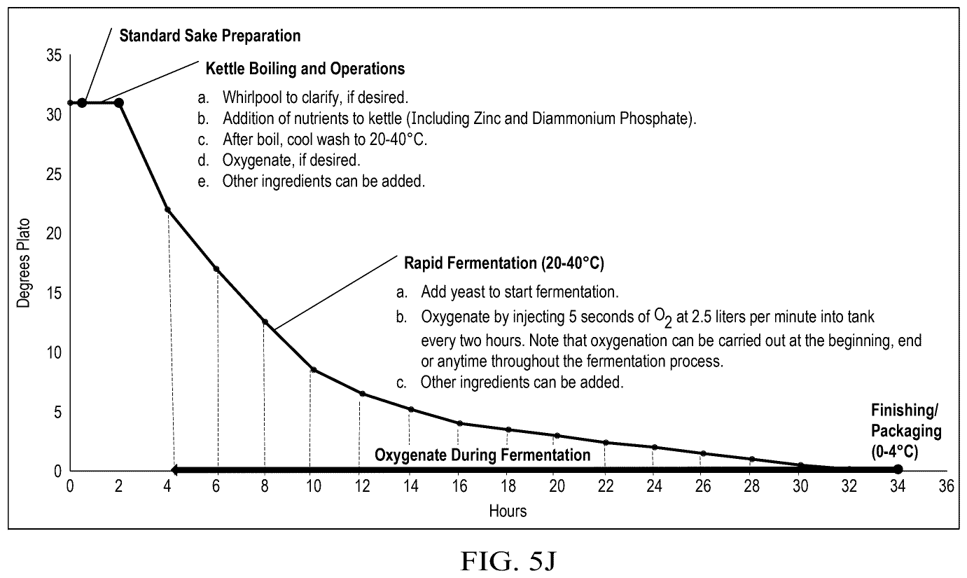

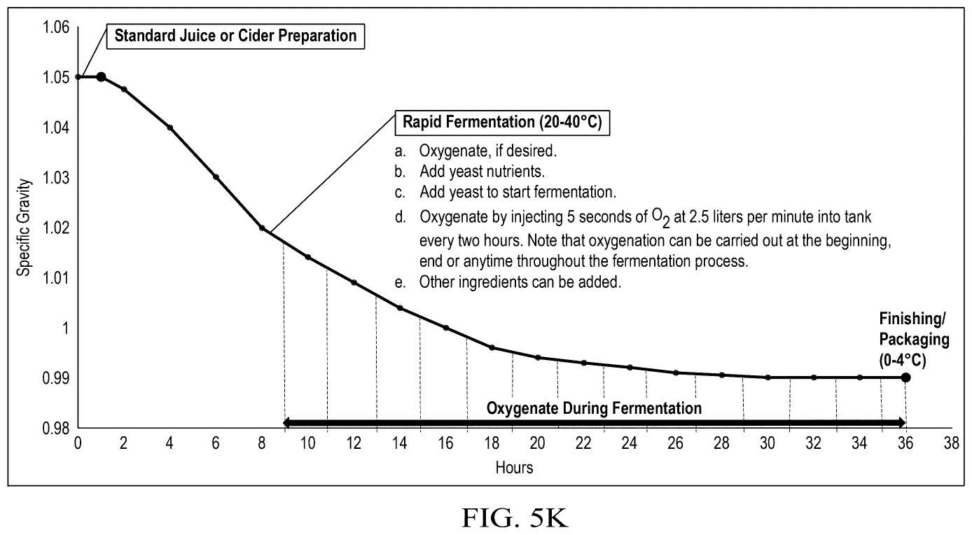

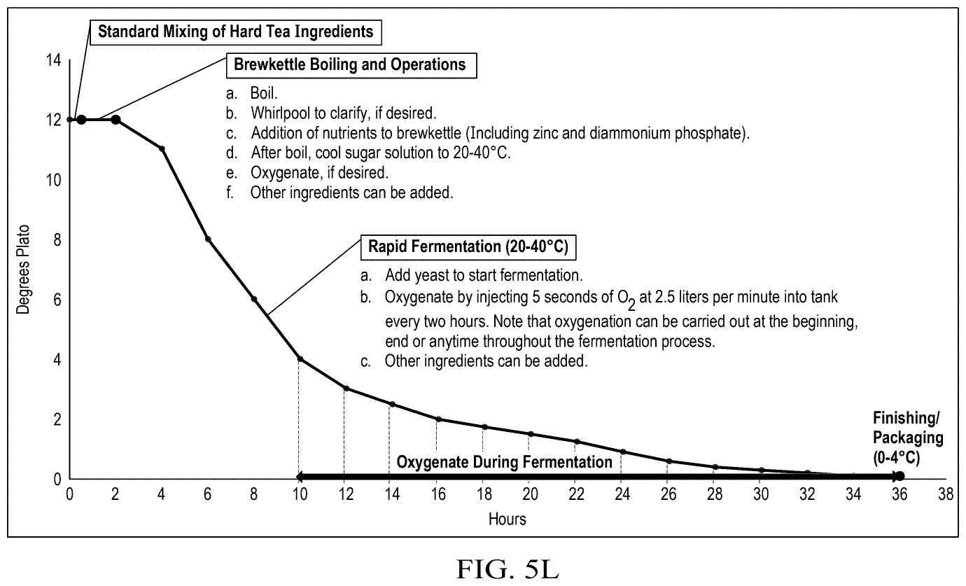

### DEFINITIONS

As used herein, the phrases “hop flavor active material” and “hop oil” refer to essential oils extracted from a hop flower or cone.

As used herein, the phrase “hop solution” refers to liquid extract or dry hop powders or dry hop pellets or natural hop flowers.

As used herein the term “yeast” refers to a eukaryotic, single-celled microorganism classified as members of the fungus kingdom.

As used herein the term “other microorganism” refers to a non-yeast organism capable of undergoing a fermentative growth cycle, including, but not limited to Brettanomyces bruxellensis, Brettanomyces lambicus, Saccharomyces diastaticus, wild yeast and genetically modified yeast.

As used herein the term “malt extract” refers to sugars, color and flavors extracted from malted grain.

As used herein the term “mixing” refers to stirring by shaking or agitating.

As used herein the term “mineral supplement” refers to minerals including but not limited to salts and electrolytes.

As used herein the term “yeast nutrients” refers to compounds that increase yeast growth rates or the growth rates of other microorganisms. Examples of yeast nutrients are zinc, copper, diammonium phosphate (DAP), yeast extract, magnesium, calcium, thiamine, biotin, free amino nitrogen, yeast hulls, wheat germ and commercially available yeast foods. Zinc can be provided in the form of zinc chloride and/or zinc sulfate. Copper can be provided in the form of copper gluconate and/or copper sulfate. Zinc and copper can also be provided by anodes that deliver metal ions into the mixture when the anodes are powered on.

As used herein the term “cellar temperature” refers to 0-4 °C.

As used herein the terms “degrees balling”, “degrees Plato” and “degrees P” refer to a measurement used to quantify the concentration of extract, or dissolved solids, (mainly sugars derived from malt but also including other soluble material in wort) as a percentage by weight.

As used herein the term “bbl” refers to beer barrels. This is a common liquid measurement abbreviation in the brewing arts equal to 31 U.S. gallons.

As used herein the phrase “finished beverage” refers to a beverage that has been cooled, optionally filtered, optionally blended with water, optionally, and is ready for packaging.

As used herein the phrase “dextrinous material” refers to a compound containing unfermentable, long-chain sugars.

As used herein, the phrase “staged oxygenation” refers to the introduction of oxygen gas at any time during the fermentation stage.

As used herein, the phrase “off-flavor” refers to an unfavorable or undesirable flavor that may be found in beverage products.

As used herein, the phrase “hard seltzer ingredients” refers to ingredients used as a base for the production of hard seltzers, including, but not limited to, sugar and water.

As used herein, the phrase “drinkability” refers to how many servings a consumer desires to drink in one sitting.

As used herein, the term “protein” refers to natural or synthetic nitrogenous organic compounds that have large molecules composed of one or more long chains of amino acids, including whey, vegetable proteins or animal proteins.

As used herein, the phrase “complete fermentation” refers to the stage of fermentation when the yeast has consumed all fermentable materials and fermentation activity stops. In some instances, complete fermentation means that the yeast ferments until there is no more fermentable material left to ferment. In some instances, complete fermentation means that the fermentation activity is arrested prematurely in order to leave residual sweetness (from the fermentable material) in the product. One method to stop fermentation is to decrease the temperature during fermentation to terminate the yeast fermentative activity. Another method to stop fermentation is to filter the yeast out of the solution, thus terminating fermentation.

As used herein, the phrase “wine must preparation” refers to the de-stemming and crushing of wine grapes into juice (must), or the dilution of concentrated wine grape must to a concentration similar to natural wine grape must.

As used herein, the phrase “standard mashing and lautering” refers to the traditional brewing process to transform malted grains into wort for brewing.

As used herein, the term “grain” refers to malted or unmalted grains selected from the group consisting of wheat, oat, rice, corn, rye, amaranth, quinoa, sorghum, teff, and spelt.

As used herein, the phrase “distiller's wash preparation” refers to traditional brewery mashing and lautering of malted grains and adjuncts, followed by boiling without hop addition.

As used herein, the phrase “preparation of unfermented kombucha” refers to the mixing together of green or black tea, sugar and water, prior to the addition of SCOBY.

As used herein, the term “SCOBY” refers to a cellulose mat that houses the bacteria and yeast cultures that turn sweet tea into kombucha. This is an acronym for “symbiotic culture of bacteria and yeast”.

As used herein, the phrase “high gravity” refers to a fermentable mixture in the range of 14-17° Plato.

As used herein, the phrase “ultra-high gravity” refers to a fermentable mixture with greater than 17° Plato.

As used herein, the phrase “sake ingredients” refers to ingredients used as a base for the production of sake, including, but not limited to, rice, water and koji.

As used herein, the phrase “standard preparation of apple juice or cider” refers to ingredients used as a fruit base for the production of fruit juice or cider, including, but not limited to fruit and sugar.

As used herein, the term “tea” refers to any products produced from the tea plant Camellia sinensis, or from any herbs, spices, or other extractable plants.

As used herein, the term “fermentables” refers to ingredients used as a base for fermentation, including, but not limited to sugar, rice, cornstarch, corn grits, flaked corn, ancient grains, fruits and vegetables.

As used herein, the term “steam” is used to describe the exposure of rice to water, at high temperature and pressure.

As used herein, the term “boil” refers to heating a mixture to boiling temperature. This temperature will vary according to the altitude where the process is occurring.

As used herein, the term “distill” refers to a process that removes alcohol from a liquid.

TABLE 1
Typical amounts of hops used in traditional
and rapid fermentation of beer

| | Traditional fermentation | | Rapid fermentation |
|---|---|---|---|
| | Range of hops | Range of hops | Amount in excess of |
| Beer type | (grams/bbl) | (grams/bbl) | traditional |
| Ale | 300-800 | 600-1600 | 2x |
| Lager | 120-200 | 180-300 | 1.5x |
| IPA | 700-1500 | 2100-4500 | 3x |
| Sour | 100-500 | 150-750 | 1.5x |
| Stout | 300-600 | 450-900 | 1.5x |
| Wheat Ale | 300-600 | 600-1200 | 2x |

For both beer-type and non-beer type beverages, higher amounts of yeast may be added during the rapid fermentation process (Tables 2 and 3).

TABLE 2
Typical fermentation times, amount of yeast used, and boiling
times for different beverages in a traditional brewing process

| Fermentation | | Yeast Added | | Boiling Time | |
|---|---|---|---|---|---|
| Time (hours) | | (grams/bbl) | | (minutes) | |
| range | optimal | range | optimal | range | optimal |

Beer & Malt-based Seltzer

| | | | | | | |
|---|---|---|---|---|---|---|
| Standard | 120-168 | 144 | 80-150 | 115 | 30-120 | 60 |
| Gravity | | | | | | |
| High Gravity | 168-216 | 192 | 110-192 | 151 | 30-120 | 60 |
| Ultra-High | 192-240 | 216 | 142-248 | 195 | 30-120 | 60 |
| Gravity | | | | | | |

Sugar-Based Seltzer

| | | | | | | |
|---|---|---|---|---|---|---|
| Standard | 168-240 | 204 | 124-228 | 176 | 1-60 | 20 |
| Gravity | | | | | | |
| High Gravity | 240-312 | 265 | 214-372 | 293 | 1-60 | 20 |
| Ultra-High | 241-335 | 288 | 298-522 | 410 | 1-60 | 20 |
| Gravity | | | | | | |
| Wine | 168-504 | 336 | 23-35 | 29 | NA | |
| Kombucha | 168-288 | 228 | 131-241 | 186 | NA | |
| Wash for | 216-288 | 252 | 110-192 | 115 | 30-120 | 60 |
| Distilling | | | | | | |
| Sake | 432-768 | 600 | 586-1000 | 793 | 30-60* | 45* |
| Hard Cider | 168-504 | 336 | 23-35 | 29 | NA | |
| Hard Tea | 168-240 | 204 | 124-228 | 176 | 1-60 | 20 |

*When producing sake, rice is steamed not boiled

TABLE 3
Typical fermentation times, amount of yeast used and boiling
times for different beverages in a rapid brewing process

| Fermentation | | Yeast Added | | Boiling Time | |
|---|---|---|---|---|---|
| Time (hours) | | (grams/bbl) | | (minutes) | |
| range | optimal | range | optimal | range | optimal |

Beer & Malt-based Seltzer

| | | | | | | |
|---|---|---|---|---|---|---|
| Standard Gravity ** (1.5x) | 30-34 | 32 | 120-225 | 173 | 30-120 | 60 |
| High Gravity ** (3.5x) | 36-40 | 38 | 385-672 | 528 | 30-120 | 60 |
| Ultra-High Gravity ** (4x) | 40-48 | 44 | 568-992 | 780 | 30-120 | 60 |

Sugar-Based Seltzer

| | | | | | | |
|---|---|---|---|---|---|---|
| Standard Gravity ** (1.5x) | 30-34 | 32 | 186-342 | 264 | 1-60 | 20 |
| High Gravity ** (2.5x) | 36-40 | 36 | 535-930 | 733 | 1-60 | 20 |
| Ultra-High Gravity ** (3.5x) | 40-48 | 43 | 1043-1827 | 1435 | 1-60 | 20 |
| Wine | 46-50 | 48 | 81-123 | 102 | NA | |
| Kombucha | 42-48 | 44 | 328-603 | 465 | NA | |
| Wash for Distilling | 46-50 | 48 | 385-672 | 403 | 30-120 | 60 |
| Sake | 46-50 | 48 | 1172-2000 | 1586* | 30-60* | 45 |
| Hard Cider | 46-50 | 48 | 81-123 | 102 | NA | |
| Hard Tea | 30-34 | 32 | 186-342 | 264 | 1-60 | 20 |

*When producing sake, rice is steamed not boiled
** Amount of yeast used in a rapid brewing process, relative to the amount of yeast used in a traditional brewing process is shown in parentheses

For both beer-type and non-beer type beverages, additional carbonation may be added. Typical carbonation levels (CO₂) of some traditional beers are shown in Table 4.

TABLE 4
Carbonation levels of traditional beers
shown as CO₂ (volume/volume ratio)

| | | Carbonation | Carbonation |
|---|---|---|---|
| Beer style | Type | (minimum) | (maximum) |
| American Amber | Ale | 2.3 | 2.8 |
| American Brown | Ale | 2.0 | 2.6 |
| American IPA | Ale | 2.2 | 2.7 |
| Belgian Pale | Ale | 2.1 | 2.7 |
| English Pale | Ale | 1.5 | 2.4 |
| Premium Bitter | Ale | 0.8 | 2.1 |
| Sweet Stout | Ale | 2.5 | 2.9 |
| Imperial Stout | Ale | 1.8 | 2.6 |
| American Pilsner | Lager | 2.5 | 2.7 |
| German Pilsner | Lager | 2.4 | 2.8 |
| Eisbock | Lager | 2.2 | 2.6 |
| Lite American | Lager | 2.5 | 2.8 |
| German Pilsner | Lager | 2.4 | 2.8 |
| Traditional Bock | Lager | 2.2 | 2.7 |

### DETAILED DESCRIPTION OF EMBODIMENTS

A method is described for rapidly producing an alcohol-containing beverage comprising the steps of mashing, boiling, fermenting and finishing, and may include the addition of hops and flavor-active materials such as spices, psychoactive materials, and/or physiologically active materials. Step 1 consists of blending a mixture of malt, water and optionally adding other fermentable materials into a traditional brewer's “mash”, followed by boiling (step 2) to create wort. Hops and other ingredients can be added during this step. Yeast nutrients are added to aid in rapid, fermentative growth of the yeast and to prevent “off-flavors” produced during the subsequent rapid fermentation.

In one embodiment yeast nutrients are selected from the group consisting of zinc at a concentration range of 0.05-5.0 mg/L and/or copper at a concentration range of 0.01-2.0 mg/L, diammonium phosphate (DAP) at a concentration range of 100 mg/L-5000 mg/L or other ammonium compounds, yeast extract, magnesium, calcium, thiamine, biotin, free amino nitrogen, yeast hulls, wheat germ and commercially available yeast foods that increase yeast growth rates or the growth rates of other microorganisms.

In one embodiment, zinc is added at a concentration range of 0.05-5.0 mg/L.

In one embodiment, copper is added at a concentration range of 0.01-2.0 mg/L.

In one embodiment, the wort is cooled to 20-40 °C. In one embodiment the wort is cooled to a temperature in the range selected from the group consisting of 20-40, 20-30, 20-25, 25-28, 28-30, 30-35 and 35-40 °C, with or without partially or fully saturating the wort with dissolved oxygen.

Step 3 consists of the addition of yeast to begin rapid fermentation of the wort. In one embodiment, yeast is added at about 1.25 to 10 times the amount than what is used in traditional brewing methods. In one embodiment, yeast is added from the group consisting of 1 to 10, 1 to 5, and 1.25 to 10 times the amount than what is used in traditional brewing methods. In one embodiment, the wort is subsequently injected repeatedly with oxygen gas for a time period selected from the group consisting of 0.01 seconds to 30 minutes, 0.01-30 seconds, 0.01-15 seconds, 0.1-1 seconds, 0-30 seconds, 0-15 seconds, 15-30 seconds, 0-5 seconds, 5-10 seconds, 10-15 seconds, 15-20 seconds, 20-25 seconds, 25-30 seconds, 30 seconds to 30 minutes, 1-30 minutes, 1-15 minutes, 15-30 minutes, 1-5 minutes, 5-10 minutes, 10-15 minutes, 15-20 minutes, 20-25 minutes and 25-30 minutes, at a rate selected from the group consisting of 0.000001-0.1, 0.1-0.5, 0.5-1, 1-5, 0.000001, 0.00001, 0.0001, 0.001, 0.01, 0.1, 0.5, 1, 1.5, 2, 2.5, 3, 3.5, 4, 4.5 and 5 liters per minute, and repeated for a time period selected from the group consisting of every 0.001-50, 12-25, 12-40, 0.5-12, 6-12, 12-25, 25-50, 3-6, 1-3, 0.001-0.1, 1-6, 1-3, 1.25, 1.5, 1.75, 2, 2.25, 2.5, 2.75, 3, 3.25, 3.5, 3.75, 4, 4.25, 4.5, 4.75, 5, 5.25, 5.5, 5.75, 6, 12, 25, 40 and 50 hours.

Flavor-active materials such as spices, psychoactive materials, and/or physiologically active materials may be added at any stage. In one embodiment, fermentation is complete within a time period selected from the group consisting of 4-48, 4-24, 4-8, 8-12, 12-16, 16-20, 20-24, 24-28, 28-32, 32-36, 36-40, 40-44, 44-48 and 24-48 hours (step 3). Product can optionally be filtered and/or blended with water, and carbonation levels can optionally be adjusted by the addition of CO₂ prior to packaging (step 4).

In one embodiment, brewer's mash mixture contains water, with or without hops, yeast nutrients, flavor-active materials such as spices, psychoactive materials, and/or physiologically active materials, and malted barley. In one embodiment the mash mixture may additionally contain malted or unmalted adjuncts such as wheat (20-60%), oats (1-10%), rice (10-60%), corn (10-60%), rye (1-5%), triticale (5-20%) or any other grain including so called “ancient” grains such as amaranth, quinoa, sorghum, teff, and spelt. In one embodiment, ancient grains may be added from 1-50%. All additions are added as a weight percent of the total mash weight. In one embodiment, an adjunct may be added in combination with a dextrinous material (unfermentable, long-chain sugars). During the mash process, the mash mixture is heated to temperatures selected from the group consisting of 30-80, 30-55, 55-80, 35, 40, 45, 50, 55, 60, 65, 70, 75 and 80 °C prior to boiling. In one embodiment, temperatures during the mash process range from 40 to 80 °C. In one embodiment, temperatures during the mash process range from 50 to 80 °C. In one embodiment, temperatures during the mash process range from 60 to 80 °C.

In one embodiment, the mash mixture is heated for 1 minute. In one embodiment the mash mixture is heated for 1 to 120 minutes. In one embodiment the mash mixture is heated for a time period selected from the group consisting of 1 to 120, 1-20, 1-60, 60-120 and 20-90 minutes. In one embodiment the mash mixture is heated for 60 to 90 minutes. In one embodiment the mash mixture is heated for 90 to 120 minutes. For beer-type beverages, in one embodiment the mash mixture is heated for 20 minutes at 60 °C, followed by heating for 40 minutes at 66 °C, followed by heating for 10 minutes at 75 °C.

In one embodiment, ammonium compounds such as diammonium phosphate are added at a concentration range of 100 mg/L-5000 mg/L to prevent or minimize a large drop in pH of the mixture as a natural reaction of rapid fermentation.

In one embodiment, the method comprises the addition of yeast during the fermentation step. In one embodiment, yeast is added in an amount selected from the group consisting of 0.1-15, 0.1-7.5, 7.5-15, 1, 2, 3, 4, 5, 6, 7, 8, 9, 10, 11, 12, 13, 14 and 15 times the amount of yeast used in traditional brewing methods.

In one embodiment, the mashed, lautered mixture, with or without flavor-active materials such as hops, spices, psychoactive materials, and/or physiologically active materials, is mixed with water and boiled for a time period selected from the group consisting of 0.1-1, 1-5, 1-60, 60-120, 5, 10, 20, 30, 40, 50, 60, 70, 80, 90, 100, 110 and 120 minutes.

In one embodiment, the mixture is cooled to a temperature in the range selected from the group consisting of 20-40, 20-30, 20-25, 25-28, 28-30, 30-35 and 35-40 °C and yeast is added to initiate fermentation.

In one embodiment, the mixture is cooled to a temperature in the range selected from the group consisting of 20-40, 20-30, 20-25, 25-28, 28-30, 30-35 and 35-40 °C and a non-yeast microorganism is added to initiate fermentation.

In one embodiment, fermentation is allowed to continue for a time period selected from the group consisting of 2-60, 2-30, 30-60, 2-6, 4-8, 6-10, 8-12, 10-14, 12-16, 14-18, 16-20, 18-22, 20-24, 22-26, 24-28, 26-30, 28-32, 30-34, 32-36, 34-38, 36-40, 38-42, 40-44, 42-46, 44-48, 46-50, 48-52, 50-54, 52-56, 54-58, and 56-60 hours.

In one embodiment, staged oxygenation is induced at a time selected from the group consisting of 0-100%, 50-100%, 0-50%, 70-100%, 0-5%, 3-8%, 5-10%, 8-13%, 10-15%, 13-18%, 15-20%, 18-23%, 20-25%, 23-28%, 25-30%, 28-33%, 30-35%, 33-38%, 35-40%, 38-43%, 40-45%, 43-48%, 45-50%, 48-53%, 50-55%, 43-58%, 55-60%, 58-63%, 60-65%, 63-68%, 65-70%, 68-73%, 70-75%, 73-78%, 75-80%, 78-83%, 80-85%, 83-88%, 85-90%, 88-93% and 95-100% of the way through the fermentation process.

In one embodiment, selected from the group consisting of at 0-100%, 50-100%, 0-50%, 70-100%, 0-5%, 3-8%, 5-10%, 8-13%, 10-15%, 13-18%, 15-20%, 18-23%, 20-25%, 23-28%, 25-30%, 28-33%, 30-35%, 33-38%, 35-40%, 38-43%, 40-45%, 43-48%, 45-50%, 48-53%, 50-55%, 43-58%, 55-60%, 58-63%, 60-65%, 63-68%, 65-70%, 68-73%, 70-75%, 73-78%, 75-80%, 78-83%, 80-85%, 83-88%, 85-90%, 88-93% and 95-100% of the way through the fermentation process, to begin staged oxygenation, the mixture is injected repeatedly with oxygen gas for a time period selected from the group consisting of 0.01 seconds to 30 minutes, 0.01-30 seconds, 0.01-15 seconds, 0.1-1 seconds, 0-30 seconds, 0-15 seconds, 15-30 seconds, 0-5 seconds, 5-10 seconds, 10-15 seconds, 15-20 seconds, 20-25 seconds, 25-30 seconds, 30 seconds to 30 minutes, 1-30 minutes, 1-15 minutes, 15-30 minutes, 1-5 minutes, 5-10 minutes, 10-15 minutes, 15-20 minutes, 20-25 minutes and 25-30 minutes, and repeated over a total time period in the time range selected from the group consisting of every 0.001-50, 12-25, 12-40, 0.5-12, 6-12, 12-25, 25-50, 3-6, 1-3, 0.001-0.1, 1-6, 1-3, 1.25, 1.5, 1.75, 2, 2.25, 2.5, 2.75, 3, 3.25, 3.5, 3.75, 4, 4.25, 4.5, 4.75, 5, 5.25, 5.5, 5.75, 6, 12, 25, 40 and 50 hours.

In one embodiment, selected from the group consisting of at 0-100%, 50-100%, 0-50%, 70-100%, 0-5%, 3-8%, 5-10%, 8-13%, 10-15%, 13-18%, 15-20%, 18-23%, 20-25%, 23-28%, 25-30%, 28-33%, 30-35%, 33-38%, 35-40%, 38-43%, 40-45%, 43-48%, 45-50%, 48-53%, 50-55%, 43-58%, 55-60%, 58-63%, 60-65%, 63-68%, 65-70%, 68-73%, 70-75%, 73-78%, 75-80%, 78-83%, 80-85%, 83-88%, 85-90%, 88-93% and 95-100% of the way through the fermentation process, to begin staged oxygenation, the mixture is injected with oxygen gas at a rate selected from the group consisting of 0.000001-0.1, 0.1-0.5, 0.5-1, 1-5, 0.000001, 0.00001, 0.0001, 0.001, 0.01, 0.1, 0.5, 1, 1.5, 2, 2.5, 3, 3.5, 4, 4.5 and 5 liters per minute.

In one embodiment, the temperature range during fermentation is selected from the group consisting of 20-40, 20-30, 20-25, 25-28, 28-30, 30-35 and 35-40 °C. In one embodiment, the temperature range during fermentation is from 25-28 °C. In one embodiment, the temperature range during fermentation is from 28-30 °C. In one embodiment, the temperature range during fermentation is from 30-32 °C. In one embodiment, the temperature range during fermentation is from 32-35 °C. In one embodiment, the temperature range during fermentation is from 35-37 °C. In one embodiment, the temperature range during fermentation is from 37-40 °C.

In one embodiment, brewer's yeast is used at fermentation temperatures selected from the group consisting of 20-40, 20-30, 20-25, 25-28, 28-30, 30-35 and 35-40 °C.

In one embodiment, non-brewing yeast strains are used at fermentation temperatures selected from the group consisting of 20-40, 20-30, 20-25, 25-28, 28-30, 30-35 and 35-40 °C. In one embodiment, additional yeast strains include, but are not limited to, baker's yeast, wine yeast, sake yeast, SCOBY, champagne yeast, distiller's yeast, and any other type of domesticated, wild or industrial yeast including genetically modified yeast. In one embodiment, thermophilic yeasts are used at temperatures up to 75 °C.

In one embodiment, genetically modified or classically modified yeast or other microorganisms, which possess genes and traits from other organisms, are used at fermentation temperatures selected from the group consisting of 20-40, 20-30, 20-25, 25-28, 28-30, 30-35 and 35-40 °C.

In one embodiment, yeast nutrients are added to aid in rapid fermentative growth of the yeast cells.

In one embodiment, dissolved oxygen is added to the mixture before the fermentation step to aid in efficient fermentation.

In one embodiment, the mixture is partially or fully saturated with dissolved oxygen before the fermentation step to aid in efficient fermentation.

In one embodiment, solutions rich in unsaturated fatty acids, such as unsaturated vegetable oil, are used to provide nourishment to the yeast or other microorganisms.

In one embodiment, the mixture is agitated or stirred, either mechanically or by directing the flow of oxygen, or other gas, to create mixing action.

In one embodiment, the carbonation method is either natural carbonation or forced carbonation, or both. Natural carbonation occurs during the fermentation process. Forced carbonation can be used to achieve a target level of 2.7, with a range between 1.5 vol/vol to 3.0 vol/vol or higher.

In one embodiment, other ingredients may be added at any time during the production of the beverage. The flavor of said beverage may be altered by the addition of a material selected from the group that may include hops, hop solutions or hop oil, hop extract, specialty malt, natural flavor, artificial flavor and combinations thereof. The flavor of said beverage may be altered by the addition of a material selected from the group comprising caffeine, vitamin supplements, mineral supplements, proteins, herbs, teas, spices, beer, wine, spirits, terpenes, cannabinoids, synthetic cannabinoids, mushrooms, psilocybin containing mushrooms, peyote, ayahuasca, mescaline and combinations thereof. These additions provide flavor and/or physiological and/or mind-altering reactions.

In one embodiment, for beer-type beverages, the method comprises increasing flavors by the addition of extra hops or hop solutions. In one embodiment extra hops are added in an amount selected from the group consisting of 0.1-100, 100-300, 300-600, 1, 2, 3, 4, 5, 6, 7, 8, 9, 10, 15, 20, 25, 30, 35, 40, 45, 50, 100, 150, 200, 250, 300, 350, 400, 450, 500, 550 and 600% of the amount used in traditional brewing methods, as measured by weight percent.

In one embodiment, for beer-type beverages, in order to compensate for the loss of hop compounds due to higher yeast content, higher amounts of hops are added to the brewing mix.

In one embodiment, an alcoholic beer beverage is produced rapidly by standard mashing and lautering of malt and water, followed by the steps in embodiments at [0070-00100]. Fermentation is complete in 24-48 hours compared to a traditional process that takes 6-9 days.

In one embodiment, an alcoholic malt-based seltzer is produced rapidly by standard mashing and lautering of malt and water, followed by the steps in embodiments at [0070-00101]. Fermentation is complete in 24-48 hours compared to a traditional process that takes 6-9 days.

In one embodiment, an alcoholic non-malt based seltzer is produced rapidly by mixing of sugar based hard seltzer ingredients, followed by the steps in embodiments at [0070-00101]. Fermentation is complete in 24-48 hours compared to a traditional process that takes 7-10 days.

In one embodiment, wine is produced rapidly by preparation of standard wine must, followed by the steps in embodiments at [0070-00101]. Fermentation is complete in 24-50 hours compared to a traditional process that takes 8-10 days.

In one embodiment, kombucha is produced rapidly by preparation of kombucha ingredients, followed by the steps in embodiments at [0070-00101]. Fermentation is complete in 24-48 hours compared to a traditional process that takes 8-10 days.

In one embodiment, a distiller's wash is produced rapidly by preparation of standard mashing and lautering of malted grains, followed by the steps in embodiments [0070-00101]. Fermentation is complete in 24-50 hours.

In one embodiment, sake is produced rapidly by mixing water with rice, followed by the steps in embodiments at [0070-00101]. Fermentation is complete in 24-50 hours compared to a traditional process that takes 8-10 days.

In one embodiment, an alcoholic cider is produced rapidly by mixing water with a fruit base, followed by the steps in embodiments at [0070-00101]. Fermentation is complete in 24-50 hours compared to a traditional process that takes 7-10 days.

In one embodiment, an alcoholic tea is produced rapidly by mixing water, sugar and tea, followed by the steps in embodiments at [0070-00101]. Fermentation is complete in 24-34 hours compared to a traditional process that takes 7-10 days.

### EXAMPLES

### Example 1—Standard Gravity Brew for Beer or Malt-Based Hard Seltzer

1) Standard mashing and lautering. Other ingredients can be added.*
2) Brewkettle boiling and operations:
   a. Boil.
   b. Adjustment to the amount of hops (increased to compensate for loss of bitterness compounds adsorbed onto the increased amount of yeast in fermentation—usually 1.5-5 times more hops than a typical brewing process)
   c. Optionally whirlpool to clarify.
   d. Addition of yeast nutrients to brewkettle (to aid in rapid, fermentative growth of yeast cells or other microorganisms). Yeast nutrients include, but are not limited to, zinc, copper and diammonium phosphate (DAP).
   e. After boiling, cool wort to 30 °C (compared to a typical 10-12 °C, to start fermentation)
   f. Saturate cool wort with dissolved oxygen (compared to 10-20 ppm oxygen for standard aeration)
   g. Other ingredients can be added. *
3) Rapid Fermentation (can be with brewers yeast, GMO yeast, or any other suitable microorganism):
   a. Increased amount of yeast to start fermentation—350 grams yeast per bbl, for a 12° Plato starting point; (compared to 100 grams yeast per degree bbl for a typical start—about 3.5 times more yeast than a typical brewing process)
   b. At 20 hours into fermentation, begin oxygenation by injecting oxygen gas for 5 seconds at 2.5 liters per minute into tank every two hours until fermentation is complete (at about 24 to 48 hours.) Note that oxygenation can be carried out at the beginning, end or any time throughout the fermentation process.
   c. Other ingredients can be added.*
4) Standard Finishing:
   a. Transfer to tank at 4 °C; should be 1.5-3° Plato and pH 4.0-4.3
   b. Other ingredients can be added.*
   c. Filter, dilute with process water to appropriate alcohol content, carbonate and package. * Add other ingredients such as hops or hop flavor-active materials, spices, herbs, specialty malts, psychoactive materials, physiologically active materials, natural or artificial flavors, caffeine, vitamins and supplements, mineral supplements, proteins, herbs, teas, spices, terpenes, or cannabinoids, synthetic cannabinoids, mushrooms, psilocybin containing mushrooms, peyote, ayahuasca, mescaline and combinations thereof.

TABLE 5
Change in Degrees Plato over time for Example 1

| | Degrees |
|---|---|
| Hours | Plato |
| 0 | 12 |
| 3 | 12 |
| 4.5 | 12 |
| 6 | 11 |
| 8 | 8.5 |
| 10 | 6 |
| 12 | 5 |
| 14 | 4.2 |
| 16 | 3.8 |
| 18 | 3.4 |
| 20 | 3.3 |
| 22 | 3.2 |
| 24 | 3.075 |
| 26 | 2.95 |
| 28 | 2.8 |
| 30 | 2.7 |
| 32 | 2.6 |
| 34 | 2.55 |
| 36 | 2.5 |

### Example 2—High Gravity Brew for Beer or Malt-Based Hard Seltzer

1) Standard mashing and lautering. Other ingredients can be added.*
2) Brewkettle boiling and operations:
   a. Boil.
   b. Adjustment to the amount of hops (increased to compensate for loss of bitterness compounds adsorbed onto the increased amount of yeast in fermentation—usually 3 times more hops than a typical brewing process)
   c. Optionally whirlpool to clarify.
   d. Addition of yeast nutrients to brewkettle (to aid in rapid, fermentative growth of yeast cells or other microorganisms). Yeast nutrients include, but are not limited to, zinc, copper and diammonium phosphate (DAP).
   e. After boiling, cool wort to 25 °C (compared to a typical 10-12 °C, to start fermentation)
   f. Oxygenate cooled wort with dissolved oxygen to 30-40 ppm (compared to 10-20 ppm oxygen for standard aeration).
   g. Other ingredients can be added.*
3) Rapid Fermentation (can be with brewers yeast, GMO yeast, or any other suitable microorganism):
   a. Fermentation is carried out under a head pressure of 30 to 40 psi to simulate the hydrostatic pressure of a tall fermentation tank.
   b. Increased amount of yeast to start fermentation—500 grams yeast per bbl for an 18° Plato starting point; (compared to 100 grams yeast per bbl for a normal start—about 5 times more yeast than a typical brewing process).
   c. At 20 hours into fermentation, begin oxygenation by injecting oxygen gas for 10 seconds at 1.0 liter per minute into tank every two hours until fermentation is complete (at about 24 to 48 hours.) Note that oxygenation can be carried out at the beginning, end or any time throughout the fermentation process.
   d. Other ingredients can be added. *
4) Standard Finishing:
   a. Transfer to tank at 4 °C; should be 5° Plato and pH 4.0-4.3
   b. Other ingredients can be added.*
   c. Filter, dilute with process water to appropriate alcohol content, carbonate and package. * Add other ingredients such as hops or hop flavor-active materials, spices, herbs, specialty malts, psychoactive materials, physiologically active materials, natural or artificial flavors, caffeine, vitamins and supplements, mineral supplements, proteins, herbs, teas, spices, terpenes, or cannabinoids, synthetic cannabinoids, mushrooms, psilocybin containing mushrooms, peyote, ayahuasca, mescaline and combinations thereof.

TABLE 6
Change in Degrees Plato over time for Example 2

| | Degrees |
|---|---|
| Hours | Plato |
| 0 | 18 |
| 3 | 18 |
| 4.5 | 18 |
| 6 | 15 |
| 8 | 12 |
| 10 | 9 |
| 12 | 7 |
| 14 | 6.2 |
| 16 | 5.8 |
| 18 | 5.7 |
| 20 | 5.6 |
| 22 | 5.5 |
| 24 | 5.4 |
| 26 | 5.3 |
| 28 | 5.2 |
| 30 | 5.15 |
| 32 | 5.1 |
| 34 | 5.05 |
| 36 | 5 |

### Example 3—Ultra High Gravity Brew for Beer or Malt-Based Hard Seltzer

1) Standard mashing and lautering. Other ingredients can be added.*
2) Brewkettle boiling and operations:
   a. Boil.
   b. Adjustment to the amount of hops (increased to compensate for loss of bitterness compounds adsorbed onto the increased amount of yeast in fermentation—usually 3 times more hops than a typical brewing process)
   c. Optionally whirlpool to clarify.
   d. Addition of yeast nutrients to brewkettle (to aid in rapid, fermentative growth of yeast cells or other microorganisms). Yeast nutrients include, but are not limited to, zinc, copper and diammonium phosphate (DAP).
   e. After boiling, cool wort to 25 °C (compared to a typical 10-12 °C, to start fermentation)
   f. Oxygenate cooled wort with dissolved oxygen to 30-40 ppm (compared to 10-20 ppm oxygen for standard aeration).
   g. Other ingredients can be added.*
3) Rapid Fermentation (can be with brewers yeast, GMO yeast, or any other suitable microorganism):
   a. Fermentation is carried out under a head pressure of 30 to 40 psi to simulate the hydrostatic pressure of a tall fermentation tank.
   b. Increased amount of yeast to start fermentation—750 grams yeast per bbl for a 25° Plato starting point; (compared to 100 grams yeast per bbl for normal start—about 7.5 times more yeast than a typical brewing process).
   c. At 20 hours into fermentation, begin oxygenation by injecting oxygen gas for 5 seconds at 3.0 liters per minute into tank every two hours until fermentation is complete (at about 24 to 48 hours.) Note that oxygenation can be carried out at the beginning, end or any time throughout the fermentation process.
   d. Other ingredients can be added. *
4) Standard Finishing:
   a. Transfer to tank at 4 °C; should be 1.5-3° Plato and pH 4.0-4.3
   b. Other ingredients can be added.*
   c. Filter, dilute with process water to appropriate alcohol content, carbonate and package. * Add other ingredients such as hops or hop flavor-active materials, spices, herbs, specialty malts, psychoactive materials, physiologically active materials, natural or artificial flavors, caffeine, vitamins and supplements, mineral supplements, proteins, herbs, teas, spices, terpenes, or cannabinoids, synthetic cannabinoids, mushrooms, psilocybin containing mushrooms, peyote, ayahuasca, mescaline and combinations thereof.

TABLE 7
Change in Degrees Plato over time for Example 3

| | Degrees |
|---|---|
| Hours | Plato |
| 0 | 25 |
| 3 | 25 |
| 4.5 | 25 |
| 6 | 15 |
| 8 | 12 |
| 10 | 9 |
| 12 | 7 |
| 14 | 6 |
| 16 | 5 |
| 18 | 4.5 |
| 20 | 4 |
| 22 | 3.5 |
| 24 | 3.4 |
| 26 | 3.3 |
| 28 | 3.2 |
| 30 | 3.15 |
| 32 | 3.1 |
| 34 | 3.05 |
| 36 | 3 |

### Example 4—Standard Gravity Sugar Based Hard Seltzer

1) Standard mixing of hard seltzer ingredients including water and dextrose. Other ingredients can be added. *
2) Brewkettle boiling and operations:
   a. Boil.
   b. Optionally whirlpool.
   c. Addition of yeast nutrients to brewkettle (to aid in rapid, fermentative growth of yeast cells or other microorganisms). Yeast nutrients include, but are not limited to, zinc, copper and diammonium phosphate (DAP).
   d. After boiling, cool to 30 °C (compared to a normal 10-12 °C, to start fermentation)
   e. Oxygenate cooled sugar solution with dissolved oxygen to 30-40 ppm (compared to 10-20 ppm oxygen for standard aeration).
   f. Other ingredients can be added.*
3) Fermentation (can be with brewer's yeast, distiller's yeast, or any other suitable microorganism):
   a. Increased amount of yeast to start fermentation—350 grams yeast per bbl for a 12° Plato starting point; (compared to 100 grams yeast per bbl for a normal start—about 3.5 times more yeast than a typical brewing process).
   b. At 8 hours into fermentation, begin by injecting oxygen gas for 5 seconds, at 2.5 liters per minute, into tank every two hours until fermentation is complete (at about 24 to 48 hours). Note that oxygenation can be carried out at the beginning, end or any time throughout the fermentation process.
   c. Other ingredients can be added.*
4) Standard Finishing:
   a. Transfer to tank at 4 °C; should be 0° Plato and pH 3.0-5.5
   b. Other ingredients can be added. *
   c. Filter, dilute with process water to appropriate alcohol content, carbonate and package. * Add other ingredients such as hops or hop flavor-active materials, spices, herbs, specialty malts, psychoactive materials, physiologically active materials, natural or artificial flavors, caffeine, vitamins and supplements, proteins, mineral supplements, other alcohols (i.e. vodka), herbs, teas, spices, terpenes, or cannabinoids, synthetic cannabinoids, mushrooms,

TABLE 8
Change in Degrees Plato over time for Example 4

| | Degrees |
|---|---|
| Hours | Plato |
| 0 | 12 |
| 0.5 | 12 |
| 2 | 12 |
| 4 | 11 |
| 6 | 8 |
| 8 | 6 |
| 10 | 4 |
| 12 | 3 |
| 14 | 2.5 |
| 16 | 2 |
| 18 | 1.75 |
| 20 | 1.5 |
| 22 | 1.25 |
| 24 | 0.9 |
| 26 | 0.6 |
| 28 | 0.4 |
| 30 | 0.3 |
| 32 | 0.2 |
| 34 | 0.1 |
| 36 | 0 |

### Example 5—High Gravity Sugar Based Hard Seltzer

1) Standard mixing of hard seltzer ingredients including water and dextrose. Other ingredients can be added. *
2) Brewkettle boiling and operations:
   a. Boil.
   b. Optionally whirlpool.
   c. Addition of yeast nutrients to brewkettle (to aid in rapid, fermentative growth of yeast cells or other microorganisms). Yeast nutrients include, but are not limited to, zinc, copper and diammonium phosphate (DAP).
   d. After boiling, cool to 30 °C (compared to a normal 10-12 °C, to start fermentation)
   e. Oxygenate cooled sugar solution with dissolved oxygen to 30-40 ppm (compared to 10-20 ppm oxygen for standard aeration).
   f. Other ingredients can be added.*
3) Fermentation (can be with brewer's yeast, distiller's yeast, or any other suitable microorganism):
   a. Increased amount of yeast to start fermentation—500 grams yeast per bbl for an 18° Plato starting point; (compared to 100 grams yeast per bbl for normal start—about 5 times more yeast than a typical brewing process).
   b. At 8 hours into fermentation, begin by injecting oxygen gas for 10 seconds, at 1.0 liter per minute, into tank every two hours until fermentation is complete (at about 24 to 48 hours). Note that oxygenation can be carried out at the beginning, end or any time throughout the fermentation process.
   c. Other ingredients can be added.*
4) Standard Finishing:
   a. Transfer to tank at 4 °C; should be 0° Plato and pH 3.0-5.5
   b. Other ingredients can be added. *
   c. Filter, dilute with process water to appropriate alcohol content, carbonate and package. * Add other ingredients such as hops or hop flavor-active materials, spices, herbs, specialty malts, psychoactive materials, physiologically active materials, natural or artificial flavors, caffeine, vitamins and supplements, proteins, mineral supplements, other alcohols (i.e. vodka), herbs, teas, spices, terpenes, or cannabinoids, synthetic cannabinoids, mushrooms, psilocybin containing mushrooms, peyote, ayahuasca, mescaline and combinations thereof.

TABLE 9
Change in Degrees Plato over time for Example 5

| | Degrees |
|---|---|
| Hours | Plato |
| 0 | 18 |
| 0.5 | 18 |
| 2 | 18 |
| 4 | 16 |
| 6 | 11.5 |
| 8 | 8.6 |
| 10 | 5.75 |
| 12 | 4.25 |
| 14 | 3.5 |
| 16 | 3 |
| 18 | 2.5 |
| 20 | 2 |
| 22 | 1.6 |
| 24 | 1.25 |
| 26 | 1 |
| 28 | 0.75 |
| 30 | 0.5 |
| 32 | 0.2 |
| 34 | 0.1 |
| 36 | 0 |

### Example 6—Ultra High Gravity Sugar Based Hard Seltzer

1) Standard mixing of hard seltzer ingredients including water and dextrose. Other ingredients can be added. *
2) Brewkettle boiling and operations:
   a. Boil.
   b. Optionally whirlpool.
   c. Addition of yeast nutrients to brewkettle (to aid in rapid, fermentative growth of yeast cells or other microorganisms). Yeast nutrients include, but are not limited to, zinc, copper and diammonium phosphate (DAP).
   d. After boiling, cool to 30 °C (compared to a normal 10-12 °C, to start fermentation)
   e. Oxygenate cool sugar solution with dissolved oxygen to 30-40 ppm (compared to 10-20 ppm oxygen for standard aeration).
3) Fermentation (can be with brewer's yeast, distiller's yeast, or any other suitable microorganism):
   a. Increased amount of yeast to start fermentation—750 grams yeast per bbl for a 25° Plato starting point; (compared to 100 grams yeast per degree Plato for normal start—about 7.5 times more yeast than a typical brewing process).
   b. At 2 hours into fermentation, begin by injecting oxygen gas for 5 seconds, at 3.0 liters per minute, into tank every two hours until fermentation is complete (at about 24 to 48 hours). Note that oxygenation can be carried out at the beginning, end or any time throughout the fermentation process.
   c. Other ingredients can be added. *
4) Standard Finishing:
   a. Transfer to tank at 4 °C; should be 0° Plato and pH 5.0-5.5
   b. Other ingredients can be added. *
   c. Filter, dilute with process water to appropriate alcohol content, carbonate and package. * Add other ingredients such as hops or hop flavor-active materials, spices, herbs, specialty malts, psychoactive materials, physiologically active materials, natural or artificial flavors, caffeine, vitamins and supplements, proteins, mineral supplements, other alcohols (i.e. vodka), herbs, teas, spices, terpenes, or cannabinoids, synthetic cannabinoids, mushrooms,

TABLE 10
Change in Degrees Plato over time for Example 6

| | Degrees |
|---|---|
| Hours | Plato |
| 0 | 25 |
| 0.5 | 25 |
| 2 | 25 |
| 4 | 22 |
| 6 | 17 |
| 8 | 12.5 |
| 10 | 8.5 |
| 12 | 6.5 |
| 14 | 5.2 |
| 16 | 4 |
| 18 | 3.5 |
| 20 | 3 |
| 22 | 2.4 |
| 24 | 2 |
| 26 | 1.5 |
| 28 | 1 |
| 30 | 0.5 |
| 32 | 0.2 |
| 34 | 0.1 |
| 36 | 0 |

### Example 7—Wine

1) Standard preparation of wine must. Other ingredients can be added.*
2) Fermentation (can be with brewer's yeast, distiller's yeast, or any other suitable microorganism):
   a. Oxygenate wine must with dissolved oxygen to 30-40 ppm (compared to 10-20 ppm oxygen for standard aeration).
   b. Addition of yeast nutrients to fermentation tank (to aid in rapid, fermentative growth of yeast cells or other microorganisms). Yeast nutrients include, but are not limited to, zinc, copper and diammonium phosphate (DAP)
   c. Increased amount of yeast to start fermentation—24 grams yeast per gallon for a 1.090 specific gravity starting point; (compared to 3 grams yeast per gallon for normal start—about 7 times more yeast than a typical brewing process).
   d. At 8 hours into fermentation, begin by injecting oxygen gas for 5 seconds, at 2.5 liters per minute, into tank every two hours until fermentation is complete (at about 24 to 48 hours). Note that oxygenation can be carried out at the beginning, end or any time throughout the fermentation process.
   e. Other ingredients can be added.*
3) Standard Finishing:
   a. Transfer to tank at 4 °C; specific gravity should be 0.99 and pH 3.0-4.0
   b. Other ingredients can be added. *
   c. Filter, dilute with process water to appropriate alcohol content, and package. * Add other ingredients such as hops or hop flavor-active materials, spices, herbs, specialty malts, psychoactive materials, physiologically active materials, natural or artificial flavors, caffeine, vitamins and supplements, proteins, mineral supplements, other alcohols (i.e. vodka), herbs, teas, spices, terpenes, or cannabinoids, synthetic cannabinoids, mushrooms,

TABLE 11
Change in Specific Gravity over time for Example 7

| | Specific |
|---|---|
| Hours | Gravity |
| 0 | 1.090 |
| 1 | 1.090 |
| 2 | 1.070 |
| 4 | 1.050 |
| 6 | 1.030 |
| 8 | 1.020 |
| 10 | 1.014 |
| 12 | 1.009 |
| 14 | 1.005 |
| 16 | 1.000 |
| 18 | 0.996 |
| 20 | 0.994 |
| 22 | 0.993 |
| 24 | 0.992 |
| 26 | 0.991 |
| 28 | 0.991 |
| 30 | 0.990 |
| 32 | 0.990 |
| 34 | 0.990 |
| 36 | 0.990 |

### Example 8—Kombucha

1) Standard preparation of unfermented kombucha. Other ingredients can be added.*
2) Fermentation with SCOBY which stands for Symbiotic Culture of Bacteria and Yeast (can also be with brewer's yeast, distiller's yeast, or any other suitable microorganism):
   a. Boil.
   b. Optionally oxygenate.
   c. Addition of yeast nutrients to fermentation tank (to aid in rapid, fermentative growth of yeast cells or other microorganisms). Yeast nutrients include, but are not limited to, zinc, copper and diammonium phosphate (DAP)
   d. Increased amount of yeast to start fermentation—250 grams yeast per bbl for a 1.030 specific gravity starting point; (compared to 100 grams yeast per barrel for normal start—about 2.5 times more yeast than a typical brewing process).
   e. At 6 hours into fermentation, begin by injecting oxygen gas for 10 seconds, at 3.0 liters per minute, into tank every two hours until fermentation is complete (at about 24 to 48 hours). Note that oxygenation can be carried out at the beginning, end or any time throughout the fermentation process.
   f. Other ingredients can be added.*
3) Standard Finishing:
   a. Transfer to tank at 4 °C; specific gravity should be 1.016 and pH 2.5-3.5
   b. Other ingredients can be added. *
   c. Filter, dilute with process water to appropriate alcohol content, carbonate and package. * Add other ingredients such as hops or hop flavor-active materials, spices, herbs, specialty malts, psychoactive materials, physiologically active materials, natural or artificial flavors, caffeine, vitamins and supplements, proteins, mineral supplements, other alcohols (i.e. vodka), herbs, teas, spices, terpenes, or cannabinoids, synthetic cannabinoids, mushrooms,

TABLE 12
Change in Specific Gravity over time for Example 8

| | Specific |
|---|---|
| Hours | gravity |
| 0 | 1.03 |
| 4.5 | 1.03 |
| 6 | 1.0282 |
| 8 | 1.026 |
| 10 | 1.0235 |
| 12 | 1.021 |
| 14 | 1.0195 |
| 16 | 1.0184 |
| 18 | 1.0178 |
| 20 | 1.0174 |
| 22 | 1.017 |
| 24 | 1.0167 |
| 26 | 1.0165 |
| 28 | 1.0163 |
| 30 | 1.0162 |
| 32 | 1.0161 |
| 34 | 1.016 |
| 36 | 1.016 |

### Example 9—Wash for Distilling

1) Standard mashing and lautering. Other ingredients can be added.*
2) Kettle boiling and operations:
   a. Boil.
   b. Whirlpool to clarify.
   c. Addition of yeast nutrients to brewkettle (to aid in rapid, fermentative growth of yeast cells or other microorganisms). Yeast nutrients include, but are not limited to, zinc, copper and diammonium phosphate (DAP).
   d. After boiling, cool wash to 25 °C (compared to a typical 10-12 °C, to start fermentation)
   e. Oxygenate with dissolved oxygen to 30-40 ppm (compared to 10-20 ppm oxygen for standard aeration).
   f. Other ingredients can be added. *
3) Rapid Fermentation (can be with distiller's yeast, GMO yeast, or any other suitable microorganism):
   a. Increased amount of yeast to start fermentation—70 grams yeast per degree Plato/bbl for a 17° Plato starting point; (compared to 10 grams yeast per degree Plato for normal start—about 7 times more yeast than a typical brewing process).
   b. At 10 hours into fermentation, (note that oxygenation can be carried out at the beginning, end or any time throughout the fermentation process) begin oxygenation by injecting oxygen gas for 5 seconds, at 2.5 liters per minute into tank every two hours until a balling of about 3° Plato is reached. Fermentation is complete in 24 to 48 hours.
   c. Other ingredients can be added.*
4) Standard Finishing:
   a. Transfer to tank at 4 °C; should be 1.5-2° Plato and pH 4.0-4.3
   b. Other ingredients can be added.*
   c. Distill per standard distillation process. * Add other ingredients such as hops or hop flavor-active materials, spices, herbs, specialty malts, psychoactive materials, physiologically active materials, natural or artificial flavors, caffeine, vitamins and supplements, mineral supplements, proteins, herbs, teas, spices, terpenes, or cannabinoids, synthetic cannabinoids, mushrooms, psilocybin containing mushrooms, peyote, ayahuasca, mescaline and combinations thereof.

TABLE 13
Change in Degrees Plato over time for Example 9

| | Degrees |
|---|---|
| Hours | Plato |
| 0 | 17 |
| 3 | 17 |
| 4.5 | 17 |
| 6 | 13 |
| 8 | 9.1 |
| 10 | 7 |
| 12 | 6 |
| 14 | 5.5 |
| 16 | 5 |
| 18 | 4.5 |
| 20 | 4 |
| 22 | 3.75 |
| 24 | 3.5 |
| 26 | 3.25 |
| 28 | 3 |
| 30 | 2.75 |
| 32 | 2.5 |
| 34 | 2.25 |
| 36 | 2 |

### Example 10—Sake

1) Standard mixing of sake ingredients including water and white rice. Other ingredients can be added. *
2) Kettle boiling and operations:
   a. Boil.
   b. Optionally whirlpool.
   c. Addition of yeast nutrients to kettle (to aid in rapid, fermentative growth of yeast cells or other microorganisms). Yeast nutrients include, but are not limited to, zinc, copper and diammonium phosphate (DAP).
   d. After boiling, cool to 30 °C (compared to a normal 10-12 °C, to start fermentation)
   e. Oxygenate cool sugar solution with dissolved oxygen to 30-40 ppm (compared to 10-20 ppm oxygen for standard aeration).
   f. Other ingredients can be added. *
3) Fermentation (can be with sake yeast or any other suitable microorganism):
   a. Increased amount of yeast to start fermentation—750 grams yeast per bbl for a 31° Plato starting point; (compared to 100 grams yeast per degree Plato for normal start—about 7.5 times more yeast than a typical brewing process).
   b. At 2 hours into fermentation, begin by injecting oxygen gas for 5 seconds, at 3.0 liters per minute, into tank every two hours until fermentation is complete (at about 24 to 48 hours). Note that oxygenation can be carried out at the beginning, end or any time throughout the fermentation process.
   c. Other ingredients can be added.*
4) Standard Finishing:
   a. Transfer to tank at 4 °C; should be 0° Plato and pH 5.0-5.5
   b. Other ingredients can be added. *
   c. Filter, dilute with process water to appropriate alcohol content, carbonate and package. * Add other ingredients such as hops or hop flavor-active materials, spices, herbs, specialty malts, psychoactive materials, physiologically active materials, natural or artificial flavors, caffeine, vitamins and supplements, proteins, mineral supplements, other alcohols (i.e. vodka), herbs, teas, spices, terpenes, or cannabinoids, synthetic cannabinoids, mushrooms,

TABLE 14
Change in Degrees Plato over time for Example 10

| | Degrees |
|---|---|
| Hours | Plato |
| 0 | 31 |
| 0.5 | 31 |
| 2 | 31 |
| 4 | 22 |
| 6 | 17 |
| 8 | 12.5 |
| 10 | 8.5 |
| 12 | 6.5 |
| 14 | 5.2 |
| 16 | 4 |
| 18 | 3.5 |
| 20 | 3 |
| 22 | 2.4 |
| 24 | 2 |
| 26 | 1.5 |
| 28 | 1 |
| 30 | 0.5 |
| 32 | 0.2 |
| 34 | 0.1 |
| 36 | 0 |

### Example 11—Hard Cider

1) Standard preparation of apple juice or cider. Other fruit juices or ciders can be added or used separately, including pears, peaches, cherries, etc. Other ingredients can be added.*
2) Fermentation (can be with brewer's yeast, distiller's yeast, or any other suitable microorganism):
   a. Oxygenate juice or cider with dissolved oxygen to 30-40 ppm (compared to 10-20 ppm oxygen for standard aeration).
   b. Addition of yeast nutrients to fermentation tank (to aid in rapid, fermentative growth of yeast cells or other microorganisms). Yeast nutrients include, but are not limited to, zinc, copper and diammonium phosphate (DAP)
   c. Increased amount of yeast to start fermentation—350 grams yeast per bbl for a 1.050 specific gravity starting point; (compared to 100 grams yeast per bbl for normal start—about 3.5 times more yeast than a typical process).
   d. At 8 hours into fermentation, begin by injecting oxygen gas for 5 seconds, at 2.5 liters per minute, into tank every two hours until fermentation is complete (at about 24 to 48 hours). Note that oxygenation can be carried out at the beginning, end or any time throughout the fermentation process.
   e. Other ingredients can be added. *
3) Standard Finishing:
   a. Transfer to tank at 4 °C; specific gravity should be 0.99 and pH 3.0-4.0
   b. Other ingredients can be added.*
   c. Optionally filter, dilute with process water to appropriate alcohol content, and package. * Add other ingredients such as hops or hop flavor-active materials, spices, herbs, specialty malts, psychoactive materials, physiologically active materials, natural or artificial flavors, caffeine, vitamins and supplements, proteins, mineral supplements, other alcohols (i.e. vodka), herbs, teas, spices, terpenes, or cannabinoids, synthetic cannabinoids, mushrooms,

TABLE 15
Change in Specific Gravity over time for Example 11

| | Specific |
|---|---|
| Hours | Gravity |
| 0 | 1.050 |
| 1 | 1.050 |
| 2 | 1.048 |
| 4 | 1.040 |
| 6 | 1.030 |
| 8 | 1.020 |
| 10 | 1.014 |
| 12 | 1.009 |
| 14 | 1.004 |
| 16 | 1.000 |
| 18 | 0.996 |
| 20 | 0.994 |
| 22 | 0.993 |
| 24 | 0.992 |
| 26 | 0.991 |
| 28 | 0.991 |
| 30 | 0.990 |
| 32 | 0.990 |
| 34 | 0.990 |
| 36 | 0.990 |

### Example 12—Sugar Based Hard Tea

1) Mix hard tea ingredients, including water, sugar and tea. Other ingredients can be added.*
2) Brewkettle boiling and operations:
   a. Boil.
   b. Optionally whirlpool.
   c. Addition of yeast nutrients to brewkettle (to aid in rapid, fermentative growth of yeast cells or other microorganisms). Yeast nutrients include, but are not limited to, zinc, copper and diammonium phosphate (DAP).
   d. After boiling, cool to 30 °C (compared to a normal 10-12 °C, to start fermentation)
   e. Oxygenate cooled sugar solution with dissolved oxygen to 30-40 ppm (compared to 10-20 ppm oxygen for standard aeration).
   f. Other ingredients can be added.*
3) Fermentation (can be with brewer's yeast, distiller's yeast, or any other suitable microorganism):
   a. Increased amount of yeast to start fermentation—350 grams yeast per bbl for a 12° Plato starting point; (compared to 100 grams yeast per bbl for a normal start—about 3.5 times more yeast than a typical brewing process).
   b. At 8 hours into fermentation, begin by injecting oxygen gas for 8 seconds, at 2.5 liters per minute, into tank every two hours until fermentation is complete (at about 24 to 48 hours). Note that oxygenation can be carried out at the beginning, end or any time throughout the fermentation process.
   c. Other ingredients can be added.*
4) Standard Finishing:
   a. Transfer to tank at 4 °C; should be 0° Plato and pH 3.0-5.5
   b. Other ingredients can be added.*
   c. Filter, dilute with process water to appropriate alcohol content, carbonate and package. * Add other ingredients such as hops or hop flavor-active materials, spices, herbs, specialty malts, psychoactive materials, physiologically active materials, natural or artificial flavors, caffeine, vitamins and supplements, proteins, mineral supplements, other alcohols (i.e. vodka), herbs, spices, terpenes, or cannabinoids, synthetic cannabinoids, mushrooms, psilocybin containing mushrooms, peyote, ayahausca, mescaline and combinations thereof.

TABLE 16
Change in Degrees Plato over time for Example 12

| | Degrees |
|---|---|
| Hours | Plato |
| 0 | 12 |
| 0.5 | 12 |
| 2 | 12 |
| 4 | 11 |
| 6 | 8 |
| 8 | 6 |
| 10 | 4 |
| 12 | 3 |
| 14 | 2.5 |
| 16 | 2 |
| 18 | 1.75 |
| 20 | 1.5 |
| 22 | 1.25 |
| 24 | 0.9 |
| 26 | 0.6 |
| 28 | 0.4 |
| 30 | 0.3 |
| 32 | 0.2 |
| 34 | 0.1 |
| 36 | 0 |

It will be apparent to those skilled in the art that various modifications and variations can be made in the methods and compositions of the present disclosure without departing from the spirit or scope of the invention.

What is claimed is:

1. A method for producing an alcoholic beverage comprising:
a. mixing water with malt into a mash;
b. optionally adding other fermentable materials to the mash;
c. straining the mash to create a wort;
d. boiling the wort;
e. adding yeast nutrients to the wort;
f. cooling the wort to 20-40 °C;
g. adding zinc at a concentration range of 0.05-5.0 mg/L, and/or copper at a concentration range of 0.01-2.0 mg/L to the wort;
h. adding to the wort from the group consisting of yeast, other microorganisms and combinations thereof;
i. initiating staged oxygenation of the wort at a time period between 0-100% through the fermentation process, by injecting oxygen gas for 0 seconds to 30 minutes, at a rate of 0.000001-5 liters per minute, every 0.01-50 hours;
j. adding ammonium compounds such as diammonium phosphate at a concentration range of 100 mg/L-5000 mg/L;
k. optionally agitating or mixing the mixture;
l. cooling the mixture to cellar temperature;
m. optionally filtering the mixture;
n. optionally adding hops or hop solutions to the mixture;
o. optionally adding CO₂ to carbonate the mixture;
p. packaging the mixture into the resulting beverage.

2. The method according to claim 1, wherein the mixture contains 0.1-15 times more yeast than traditional methods of producing acoholic beverages from malt.

3. The method according to claim 1, wherein the addition of yeast nutrients to the wort increases the rate of fermentative growth of the yeast and reduces the formation of off flavors.

4. The method according to claims 2 and 3, wherein following the mixing of the malt, water and other fermentables, other ingredients are added to the mash from the group consisting of hop solutions, hop flavor-active materials, spices, herbs, specialty malts, psychoactive materials, physiologically active materials, natural flavors, artificial flavors, caffeine, vitamins, supplements, mineral supplements, proteins, herbs, teas, spices, terpenes, cannabinoids, synthetic cannabinoids, mushrooms, psilocybin containing mushrooms, peyote, ayahuasca, mescaline and combinations thereof.

5. The method according to claims 2 and 3, wherein following the cooling to 20-40 °C, other ingredients are added to the wort selected from the group consisting of hop solutions, hop flavor-active materials, spices, herbs, specialty malts, psychoactive materials, physiologically active materials, natural or artificial flavors, caffeine, vitamins, supplements, mineral supplements, proteins, kombucha, herbs, teas, spices, terpenes, cannabinoids, synthetic cannabinoids, mushrooms, psilocybin containing mushrooms, peyote, ayahuasca, mescaline and combinations thereof.

6. The method according to claims 2 and 3, wherein following the staged oxygenation, other ingredients are added to the wort selected from the group consisting of hop solutions, hop flavor-active materials, spices, herbs, specialty malts, psychoactive materials, physiologically active materials, natural flavors, artificial flavors, caffeine, vitamins and supplements, mineral supplements, proteins, kombucha, herbs, teas, spices, terpenes, cannabinoids, synthetic cannabinoids, mushrooms, psilocybin containing mushrooms, peyote, ayahuasca, mescaline and combinations thereof.

7. The method according to claims 2 and 3, wherein following the cooling to cellar temperature, other ingredients are added to the wort selected from the group consisting of hop solutions, hop flavor-active materials, spices, herbs, specialty malts, psychoactive materials, physiologically active materials, natural flavors, artificial flavors, caffeine, vitamins and supplements, mineral supplements, proteins, kombucha, herbs, teas, spices, terpenes, cannabinoids, synthetic cannabinoids, mushrooms, psilocybin containing mushrooms, peyote, ayahuasca, mescaline and combinations thereof.

8. The method according to claim 1, wherein for a beer-type beverage, the mixture contains 0.1-600 percent more hops than traditional methods of producing acoholic beer-type beverages from malt.

9. A method for producing an alcoholic beverage comprising:
a. mixing water with sugar into a mixture;
b. optionally adding other fermentable materials to the mixture;
c. boiling the mixture;
d. adding yeast nutrients to the mixture;
e. cooling the mixture to 20-40 °C;
f. adding zinc to the mixture at a concentration range of 0.05-5.0 mg/L and/or copper at a concentration range of 0.01-2.0 mg/L;
g. adding to the mixture from the group consisting of yeast, other microorganisms and combinations thereof;
h. initiating staged oxygenation of the mixture at a time period between 0-100% through the fermentation process, by injecting oxygen gas for 0 seconds to 30 minutes, at a rate of 0.000001-5 liters per minute, every 0.01-50 hours;
i. adding ammonium compounds such as diammonium phosphate at a concentration range of 100 mg/L-5000 mg/L;
j. optionally agitating or mixing the mixture;
k. cooling the mixture to cellar temperature;
l. optionally filtering the mixture;
m. optionally adding CO₂ to the mixture;
n. packaging the mixture into the resulting beverage.

10. The method according to claim 9, wherein the mixture contains 0.1-15 times more yeast than traditional methods of producing acoholic beverages from sugar.

11. The method according to claim 9, wherein the addition of yeast nutrients to the mixture increases the rate of fermentative growth of the yeast and reduces the formation of off flavors.

12. The method according to claims 10 and 11, wherein following the mixing of the sugar, water and other fermetables, other ingredients are added to the mixture selected from the group consisting of hop solutions, hop flavor-active materials, spices, herbs, specialty malts, psychoactive materials, physiologically active materials, natural flavors, artificial flavors, caffeine, vitamins, supplements, mineral supplements, proteins, herbs, spices, teas, terpenes, cannabinoids, synthetic cannabinoids, mushrooms, psilocybin containing mushrooms, peyote, ayahuasca, mescaline and combinations thereof.

13. The method according to claims 10 and 11, wherein following the cooling to 20-40 °C, other ingredients are added to the mixture selected from the group consisting of hop solutions, hop flavor-active materials, spices, herbs, specialty malts, psychoactive materials, physiologically active materials, natural or artificial flavors, caffeine, vitamins, supplements, mineral supplements, proteins, herbs, spices, teas, terpenes, cannabinoids, synthetic cannabinoids, mushrooms, psilocybin containing mushrooms, peyote, ayahuasca, mescaline and combinations thereof.

14. The method according to claims 10 and 11, wherein following the staged oxygenation, other ingredients are added to the mixture selected from the group consisting of hop solutions, hop flavor-active materials, spices, herbs, specialty malts, psychoactive materials, physiologically active materials, natural flavors, artificial flavors, caffeine, vitamins and supplements, mineral supplements, proteins, herbs, spices, teas, terpenes, cannabinoids, synthetic cannabinoids, mushrooms, psilocybin containing mushrooms, peyote, ayahuasca, mescaline and combinations thereof.

15. The method according to claims 10 and 11, wherein following the cooling to cellar temperature, other ingredients are added to the mixture selected from the group consisting of hop solutions, hop flavor-active materials, spices, herbs, specialty malts, psychoactive materials, physiologically active materials, natural flavors, artificial flavors, caffeine, vitamins and supplements, mineral supplements, proteins, herbs, spices, teas, terpenes, cannabinoids, synthetic cannabinoids, mushrooms, psilocybin containing mushrooms, peyote, ayahuasca, mescaline and combinations thereof.

16. A method for producing an alcoholic beverage comprising:
a. mixing water with a fruit base selected from the group consisting of fruit juice, fruit concentrate and fruit cider into a mixture;
b. holding the temperature of the mixture at 20 °-40 °C;
c. adding zinc to the mixture at a concentration range of 0.05-5.0 mg/L and/or copper at a concentration range of 0.01-2.0 mg/L;
d. adding oxygen to the mixture;
e. adding yeast nutrients to the mixture;
f. adding to the mixture from the group consisting of yeast, other microorganisms and combinations thereof;
g. initiating staged oxygenation of the mixture at a time period 0-100% through the fermentation process, by injecting oxygen gas for 0 seconds to 30 minutes, at a rate of 0.000001-5 liters per minute, every 0.01-50 hours;
h. adding ammonium compounds, such as diammonium phosphate at a concentration range of 100 mg/L-5000 mg/L;
i. optionally agitating or mixing the mixture;
j. holding the mixture at 4 °C;
k. optionally filtering the mixture;
l. optionally adding CO₂ to the mixture;
m. packaging the mixture into the resulting beverage.

17. The method according to claim 16, wherein the mixture contains 0.1-15 times more yeast than traditional methods of producing acoholic beverages from a fruit base.

18. The method according to claim 16, wherein the addition of yeast nutrients to the mixture increases the rate of fermentative growth of the yeast and reduces the formation of off flavors.

19. The method according to claims 17 and 18, wherein following the mixing of the fruit base, water and other fermetables, other ingredients are added to the mixture selected from the group consisting of hop solutions, hop flavor-active materials, spices, herbs, specialty malts, psychoactive materials, physiologically active materials, natural flavors, artificial flavors, caffeine, vitamins, supplements, mineral supplements, proteins, herbs, spices, teas, terpenes, cannabinoids, synthetic cannabinoids, mushrooms, psilocybin containing mushrooms, peyote, ayahuasca, mescaline and combinations thereof.

20. The method according to claims 17 and 18, wherein following the staged oxygenation, other ingredients are added to the mixture selected from the group consisting of hop solutions, hop flavor-active materials, spices, herbs, specialty malts, psychoactive materials, physiologically active materials, natural flavors, artificial flavors, caffeine, vitamins and supplements, mineral supplements, proteins, herbs, spices, teas, terpenes, cannabinoids, synthetic cannabinoids, mushrooms, psilocybin containing mushrooms, peyote, ayahuasca, mescaline and combinations thereof.

21. The method according to claims 17 and 18, wherein following the holding at 4 °C, other ingredients are added to the mixture selected from the group consisting of hop solutions, hop flavor-active materials, spices, herbs, specialty malts, psychoactive materials, physiologically active materials, natural or artificial flavors, caffeine, vitamins, supplements, mineral supplements, proteins, herbs, spices, teas, terpenes, cannabinoids, synthetic cannabinoids, mushrooms, psilocybin containing mushrooms, peyote, ayahuasca, mescaline and combinations thereof.

22. A method for producing an alcoholic beverage comprising:
a. mixing water with rice into a mixture;
b. optionally adding other fermentable materials to the mixture;
c. steaming the mixture;
d. adding yeast nutrients to the mixture;
e. adding zinc to the mixture at a concentration range of 0.05-5.0 mg/L and/or copper at a concentration range of 0.01-2.0 mg/L;
f. cooling the mixture to 20-40 °C;
g. adding to the mixture from the group consisting of yeast, other microorganisms and combinations thereof;
h. initiating staged oxygenation of the mixture at a time period 0-100% through the fermentation process, by injecting oxygen gas for 0 seconds to 30 minutes, at a rate of 0.000001-5 liters per minute, every 0.01-50 hours;
i. adding ammonium compounds, such as diammonium phosphate at a concentration range of 100 mg/L-5000 mg/L;
j. optionally agitating or mixing the mixture;
k. holding the mixture at 4 °C;
l. optionally filtering the mixture;
m. optionally adding CO₂ to the mixture;
n. packaging the mixture into the resulting beverage.

23. The method according to claim 22, wherein the mixture contains 0.1-15 times more yeast than traditional methods of producing acoholic beverages from rice.

24. The method according to claim 22, wherein the addition of yeast nutrients to the mixture increases the rate of fermentative growth of the yeast and reduces the formation of off flavors.

25. The method according to claims 23 and 24, wherein following the mixing of the rice, water and other fermetables, other ingredients are added to the mixture selected from the group consisting of hop solutions, hop flavor-active materials, spices, herbs, specialty malts, psychoactive materials, physiologically active materials, natural flavors, artificial flavors, caffeine, vitamins, supplements, mineral supplements, proteins, herbs, spices, teas, terpenes, cannabinoids, synthetic cannabinoids, mushrooms, psilocybin containing mushrooms, peyote, ayahuasca, mescaline and combinations thereof.

26. The method according to claims 23 and 24, wherein following the staged oxygenation, other ingredients are added to the mixture selected from the group consisting of hop solutions, hop flavor-active materials, spices, herbs, specialty malts, psychoactive materials, physiologically active materials, natural flavors, artificial flavors, caffeine, vitamins and supplements, mineral supplements, proteins, herbs, spices, teas, terpenes, cannabinoids, synthetic cannabinoids, mushrooms, psilocybin containing mushrooms, peyote, ayahuasca, mescaline and combinations thereof.

27. The method according to claims 23 and 24, wherein following the holding at 4 °C, other ingredients are added to the mixture selected from the group consisting of hop flavor-active materials, spices, herbs, specialty malts, psychoactive materials, physiologically active materials, natural or artificial flavors, caffeine, vitamins, supplements, mineral supplements, proteins, herbs, spices, teas, terpenes, cannabinoids, synthetic cannabinoids, mushrooms, psilocybin containing mushrooms, peyote, ayahuasca, mescaline and combinations thereof.

28. A method for producing an alcoholic beverage comprising:
a. mixing water with tea and into a mixture;
b. optionally adding other fermentable materials to the mixture;
c. heating the mixture to about 100 °C to boil;
d. adding yeast nutrients to the mixture;
e. adding zinc to the mixture at a concentration range of 0.05-5.0 mg/L and/or copper at a concentration range of 0.01-2.0 mg/L;
f. cooling the mixture to 20-40 °C;
g. adding from the group consisting of SCOBY, yeast, other microorganisms and combinations thereof to the mixture;
h. initiating staged oxygenation of the mixture at a time period 0-100% through the fermentation process, by injecting oxygen gas for 0 seconds to 30 minutes, at a rate of 0.000001-5 liters per minute, every 0.01-50 hours;
i. adding ammonium compounds, such as diammonium phosphate at a concentration range of 100 mg/L-5000 mg/L;
j. optionally agitating or mixing the mixture;
k. holding the mixture at 4 °C;
l. optionally filtering the mixture;
m. optionally adding CO₂ to the mixture;
n. packaging the mixture into the resulting beverage.

29. The method according to claim 28, wherein the mixture contains 0.1-15 times more yeast than traditional methods of producing acoholic beverages from SCOBY.

30. The method according to claim 28, wherein the addition of yeast nutrients to the mixture increases the rate of fermentative growth of the yeast and reduces the formation of off flavors.

31. The method according to claims 29 and 30, wherein following the mixing of the tea, water and other fermetables, other ingredients are added to the mixture selected from the group consisting of hop solutions, hop flavor-active materials, spices, herbs, specialty malts, psychoactive materials, physiologically active materials, natural flavors, artificial flavors, caffeine, vitamins, supplements, mineral supplements, proteins, herbs, spices, terpenes, cannabinoids, synthetic cannabinoids, mushrooms, psilocybin containing mushrooms, peyote, ayahuasca, mescaline and combinations thereof.

32. The method according to claims 29 and 30, wherein following the staged oxygenation, other ingredients are added to the mixture selected from the group consisting of hop solutions, hop flavor-active materials, spices, herbs, specialty malts, psychoactive materials, physiologically active materials, natural flavors, artificial flavors, caffeine, vitamins and supplements, mineral supplements, proteins, herbs, spices, terpenes, cannabinoids, synthetic cannabinoids, mushrooms, psilocybin containing mushrooms, peyote, ayahuasca, mescaline and combinations thereof.

33. The method according to claims 29 and 30, wherein following the holding at 4 °C, other ingredients are added to the mixture selected from the group consisting of hop solutions, hop flavor-active materials, spices, herbs, specialty malts, psychoactive materials, physiologically active materials, natural or artificial flavors, caffeine, vitamins, supplements, mineral supplements, proteins, herbs, spices, terpenes, cannabinoids, synthetic cannabinoids, mushrooms, psilocybin containing mushrooms, peyote, ayahuasca, mescaline and combinations thereof.

34. A method for producing an alcoholic beverage comprising:
a. mixing water with malted grains into a distilling wash;
b. optionally adding other fermentable materials to the wash;
c. boiling the wash;
d. adding yeast nutrients to the wash;
e. adding zinc to the wash at a concentration range of 0.05-5.0 mg/L, and/or copper at a concentration range of 0.01-2.0 mg/L;
f. cooling the wash to 20-40 °C;
g. adding to the wash from the group consisting of yeast, other microorganisms and combinations thereof;
h. initiating staged oxygenation of the wash at a time period between 0-100% through the fermentation process, by injecting oxygen gas for 0 seconds to 30 minutes, at a rate of 0.000001-5 liters per minute, every 0.01-50 hours;
i. adding ammonium compounds, such as diammonium phosphate at a concentration range of 100 mg/L-5000 mg/L;
j. optionally agitating or mixing the mixture;
k. holding the wash at 4 °C;
l. optionally filtering the wash;
m. distilling the wash;
n. packaging the wash into the resulting beverage.

35. The method according to claim 34, wherein the wash contains 0.1-15 times more yeast than traditional methods of producing acoholic beverages from malted grains.

36. The method according to claim 34, wherein the addition of yeast nutrients to the wash increases the rate of fermentative growth of the yeast and reduces the formation of off flavors.

37. The method according to claims 35 and 36, wherein following the mixing of the malted grains, water and other fermetables, other ingredients are added to the wash selected from the group consisting of hop flavor-active materials, spices, herbs, specialty malts, psychoactive materials, physiologically active materials, natural flavors, artificial flavors, caffeine, vitamins, supplements, mineral supplements, proteins, herbs, spices, teas, terpenes, cannabinoids, synthetic cannabinoids, mushrooms, psilocybin containing mushrooms, peyote, ayahuasca, mescaline and combinations thereof.

38. The method according to claims 35 and 36, wherein following the staged oxygenation, other ingredients are added to the wash selected from the group consisting of hop solutions, hop flavor-active materials, spices, herbs, specialty malts, psychoactive materials, physiologically active materials, natural flavors, artificial flavors, caffeine, vitamins and supplements, mineral supplements, proteins, herbs, spices, teas, terpenes, cannabinoids, synthetic cannabinoids, mushrooms, psilocybin containing mushrooms, peyote, ayahuasca, mescaline and combinations thereof.

39. The method according to claims 35 and 36, wherein following the holding at 4 °C, other ingredients are added to the wash selected from the group consisting of hop flavor-active materials, spices, herbs, specialty malts, psychoactive materials, physiologically active materials, natural or artificial flavors, caffeine, vitamins, supplements, mineral supplements, proteins, herbs, spices, teas, terpenes, cannabinoids, synthetic cannabinoids, mushrooms, psilocybin containing mushrooms, peyote, ayahuasca, mescaline and combinations thereof.

40. A method for producing an alcoholic beverage comprising:
a. mixing water with sugar and tea into a mixture;
b. boiling the mixture;
c. adding yeast nutrients to the mixture;
d. adding zinc to the mixture at a concentration range of 0.05-5.0 mg/L, and/or copper at a concentration range of 0.01-2.0 mg/L;
e. cooling the mixture to 20-40 °C;
f. adding to the mixture from the group consisting of yeast, other microorganisms and combinations thereof;
g. initiating staged oxygenation of the mixture at a time period between 0-100% through the fermentation process, by injecting oxygen gas for 0 seconds to 30 minutes, at a rate of 0.000001-5 liters per minute, every 0.01-50 hours;
h. adding ammonium compounds, such as diammonium phosphate at a concentration range of 100 mg/L-5000 mg/L;
i. optionally agitating or mixing the mixture;
j. holding the mixture at 4 °C;
k. optionally filtering the mixture;
l. optionally adding CO₂ to the mixture;
m. packaging the mixture into the resulting beverage.

41. The method according to claim 40, wherein the mixture contains 0.1-15 times more yeast than traditional methods of producing acoholic beverages from water, sugar and tea.

42. The method according to claim 40, wherein the addition of yeast nutrients to the mixture increases the rate of fermentative growth of the yeast and reduces the formation of off flavors.

43. The method according to claims 41 and 42, wherein following the mixing of the sugar and tea, other ingredients are added to the mixture selected from the group consisting of hop solutions, hop flavor-active materials, spices, herbs, specialty malts, psychoactive materials, physiologically active materials, natural flavors, artificial flavors, caffeine, vitamins, supplements, mineral supplements, proteins, herbs, spices, terpenes, cannabinoids, synthetic cannabinoids, mushrooms, psilocybin containing mushrooms, peyote, ayahuasca, mescaline and combinations thereof.

44. The method according to claims 41 and 42, wherein following the staged oxygenation, other ingredients are added to the mixture selected from the group consisting of hop solutions, hop flavor-active materials, spices, herbs, specialty malts, psychoactive materials, physiologically active materials, natural flavors, artificial flavors, caffeine, vitamins and supplements, mineral supplements, proteins, herbs, spices, terpenes, cannabinoids, synthetic cannabinoids, mushrooms, psilocybin containing mushrooms, peyote, ayahuasca, mescaline and combinations thereof.

45. The method according to claims 41 and 42, wherein following the holding at 4 °C, other ingredients are added to the mixture selected from the group consisting of hop solutions, hop flavor-active materials, spices, herbs, specialty malts, psychoactive materials, physiologically active materials, natural or artificial flavors, caffeine, vitamins, supplements, mineral supplements, proteins, herbs, spices, terpenes, cannabinoids, synthetic cannabinoids, mushrooms, psilocybin containing mushrooms, peyote, ayahuasca, mescaline and combinations thereof.
